(19) United States
(12) Patent Application Publication
(10) Pub. No.: US 2026/0177946 A1
(43) Pub. Date: Jun. 25, 2026

(54) DEVELOPING APPARATUS

(71) Applicant: CANON KABUSHIKI KAISHA, Tokyo (JP)

(72) Inventor: Tomonori Yuyama, Tokyo (JP)

(21) Appl. No.: 19/416,114

(22) Filed: Dec. 11, 2025

(30) Foreign Application Priority Data
Dec. 20, 2024 (JP) 2024-225246

(51) Int. Cl. G03G 15/09; G03G 21/20

(52) U.S. Cl. CPC G03G 15/0921; G03G 15/0942; G03G 21/206; G03G 2215/0609

(57) ABSTRACT

In a state where an edge of a second duct wall on the suction port side is referred to as a point P, a point on an outer peripheral surface of a first rotatable member closest to the second duct wall is referred to as a point U, a point where a straight line passing the point P and a rotation center O of the first rotatable member intersects the outer peripheral surface of the first rotatable member is referred to as a point Q, and a sign of the Fθ is positive in a state where a direction of the Fθ is a same direction as the rotational direction of the first rotatable member, Fθ<0 is satisfied across a range from the point Q to the point U with respect to the rotational direction of the first rotatable member.

### BACKGROUND

### Field of the Technology

The present disclosure relates to a developing apparatus that develops an electrostatic latent image formed on an image bearing member with a developer.

### Description of the Related Art

Image forming apparatuses are equipped with a developing apparatus that attaches a developer to an electrostatic latent image formed on a photosensitive drum and develops the electrostatic latent image into a toner image. A two-component developer including a toner and a carrier is widely used as the developer. The developing apparatus is equipped with a developing roller including a developing sleeve and a magnet disposed non-rotatably inside the developing sleeve, wherein the developer is borne on the developing roller, and the developer is fed to a development region that faces a photosensitive drum along with the rotation of the developing sleeve. In the development region, the electrostatic latent image on the photosensitive drum is developed into a toner image. In such a developing apparatus, toner is easily scattered along with the carrying of the developer on the rotating developing sleeve.

When toner scattering occurs, the scattered toner will accumulate in the vicinity of the developing apparatus and the photosensitive drum. Thereafter, due to the accumulated toner falling onto the developing sleeve or onto the photosensitive drum by vibration caused during formation of image or maintenance, image defects may occur. US2021/0096500 discloses a developing apparatus equipped with a duct for sucking in scattered toner.

When sucking the toner into the duct, carrier may also enter the duct. If the carrier reaches a suction path of the duct, the carrier will accumulate inside the suction path, narrowing the cross-sectional area of the flow path, such that the necessary flow rate of air cannot be obtained, and as a result, the scattered toner cannot be sucked in sufficiently. Further, if a filter for collecting toner is disposed in the path of the duct, the filter will be clogged with carrier particles, by which suction force is deteriorated, such that the scattered toner cannot be sucked in sufficiently. Thus, US2021/0096500 discloses a configuration in which a recessed portion is formed on a lower surface of the path inside the duct to collect the carrier by the recessed portion, such that the carrier entering the duct when sucking the scattered toner is prevented from reaching the filter.

However, under a condition of use in which the image forming apparatus is operated at high speed, the amount of separation of carrier from the developing sleeve is increased, such that according to the configuration disclosed in US2021/0096500, there is a risk that the recessed portion for collecting the carrier may be filled and overflown with the carrier. If such a situation occurs, the carrier may enter the suction path and accumulate therein, such that scattered toner cannot be sucked sufficiently into the suction path, and image defects may occur.

### SUMMARY

One aspect of the present disclosure is to suppress the sucking of carrier into the duct portion.

According to a first aspect of the present disclosure, a developing apparatus includes a developing container including a first chamber configured to contain a developer including a toner and a carrier, and a second chamber partitioned from the first chamber by a partition wall, a first rotatable member to which the developer is supplied, the first rotatable member being configured to carry and feed the developer to a developing position where an electrostatic latent image formed on an image bearing member is developed, a first magnet provided non-rotatably and stationarily inside the first rotatable member, the first magnet having a first magnetic pole provided to face the image bearing member at the developing position, a second magnetic pole provided downstream of the first magnetic pole and adjacent to the first magnetic pole, with respect to a rotational direction of the first rotatable member and having a different magnetic polarity as that of the first magnetic pole, a third magnetic pole provided downstream of the second magnetic pole and adjacent to the second magnetic pole, with respect to the rotational direction of the first rotatable member, and having a different magnetic polarity as that of the second magnetic pole, a fourth magnetic pole provided downstream of the third magnetic pole and adjacent to the third magnetic pole, with respect to the rotational direction of the first rotatable member, and having a different magnetic polarity as that of the third magnetic pole, and a fifth magnetic pole provided downstream of the fourth magnetic pole and adjacent to the fourth magnetic pole, with respect to the rotational direction of the first rotatable member, and having a different magnetic polarity as that of the fourth magnetic pole, a second rotatable member disposed to face the first rotatable member and configured to receive the developer delivered from the first rotatable member by a magnetic field generated by the first magnet, the second rotatable member being configured to carry and feed the developer after developing the electrostatic latent image to collect the developer in the second chamber, a second magnet provided non-rotatably and stationarily inside the second rotatable member, the second magnet having a sixth magnetic pole having a different magnetic polarity as that of the fifth magnetic pole, wherein the developer after developing the electrostatic latent image is delivered from the first rotatable member to the second rotatable member by a magnetic field generated between the fifth magnetic pole and the sixth magnetic pole, and, a duct portion including a suction port and configured to extend downstream in the rotational direction of the first rotatable member from the suction port, the duct portion including a first duct wall disposed to face the second rotatable member, and a second duct wall disposed to face the first rotatable member, and also disposed to face the first duct wall and configured to form a space between the first duct wall through which air sucked in through the suction port flows, the second duct wall being positioned on an outer side than the first duct wall with respect to a rotation center of the second rotatable member in a radial direction of the second rotatable member. In a state where an edge of the second duct wall on the suction port side, which is an end point on the first rotatable member side, is referred to as a point P, a point on an outer peripheral surface of the first rotatable member where an absolute value of magnetic flux density of the third magnetic pole in a normal direction with respect to the outer peripheral surface of the first rotatable member is a maximum value is referred to as a point T, a point on an outer peripheral surface of the first rotatable member where an absolute value of magnetic flux density of the fourth magnetic pole in a normal direction with respect to the outer peripheral surface of the first rotatable member is a maximum value is referred to as a point R, a point on an outer peripheral surface of the first rotatable member closest to the second duct wall is referred to as a point U, and a point where a straight line passing the point P and a rotation center O of the first rotatable member intersects the outer peripheral surface of the first rotatable member is referred to as a point Q, the point Q is positioned downstream of the point T and upstream of the point R with respect to the rotational direction of the first rotatable member, the point U is positioned downstream of the point Q and upstream of the point R with respect to the rotational direction of the first rotatable member. In a state where a magnetic force in a tangential direction with respect to the outer peripheral surface of the first rotatable member among the magnetic force acting on a carrier on the outer peripheral surface of the first rotatable member is referred to as Fθ, a sign of the Fθ is positive in a state where a direction of the Fθ is a same direction as the rotational direction of the first rotatable member, and a sign of the Fθ is negative in a state where a direction of the Fθ is an opposite direction as the rotational direction of the first rotatable member, Fθ<0 is satisfied across a range from the point Q to the point U with respect to the rotational direction of the first rotatable member.

According to a second aspect of the present disclosure, a developing apparatus includes a developing container including a first chamber configured to contain a developer including a toner and a carrier, and a second chamber partitioned from the first chamber by a partition wall, a first rotatable member to which the developer is supplied, the first rotatable member being configured to carry and feed the developer to a developing position where an electrostatic latent image formed on an image bearing member is developed, a first magnet provided non-rotatably and stationarily inside the first rotatable member, the first magnet having a first magnetic pole provided to face the image bearing member at the developing position, a second magnetic pole provided downstream of the first magnetic pole and adjacent to the first magnetic pole with respect to a rotational direction of the first rotatable member and having a different magnetic polarity as that of the first magnetic pole, a third magnetic pole provided downstream of the second magnetic pole and adjacent to the second magnetic pole, with respect to the rotational direction of the first rotatable member, and having a different magnetic polarity as that of the second magnetic pole, a fourth magnetic pole provided downstream of the third magnetic pole and adjacent to the third magnetic pole, with respect to the rotational direction of the first rotatable member, and having a different magnetic polarity as that of the third magnetic pole, and a fifth magnetic pole provided downstream of the fourth magnetic pole and adjacent to the fourth magnetic pole, with respect to the rotational direction of the first rotatable member, and having a different magnetic polarity as that of the fourth magnetic pole, a second rotatable member disposed to face the first rotatable member and configured to receive the developer delivered from the first rotatable member by a magnetic field generated by the first magnet, the second rotatable member being configured to carry and feed the developer after developing the electrostatic latent image to collect the developer in the second chamber, a second magnet provided non-rotatably and stationarily inside the second rotatable member, the second magnet having a sixth magnetic pole having a different magnetic polarity as that of the fifth magnetic pole, wherein the developer after developing the electrostatic latent image is delivered from the first rotatable member to the second rotatable member by a magnetic field generated between the fifth magnetic pole and the sixth magnetic pole, and, a duct portion including a suction port and configured to extend downstream in the rotational direction of the first rotatable member from the suction port, the duct portion including a first duct wall disposed to face the second rotatable member, and a second duct wall disposed to face the first rotatable member, and also disposed to face the first duct wall and configured to form a space between the first duct wall through which air sucked in through the suction port flows, the second duct wall being positioned on an outer side than the first duct wall with respect to a rotation center of the second rotatable member in a radial direction of the second rotatable member. In a state where an edge of the second duct wall on the suction port side, which is an end point on the first rotatable member side, is referred to as a point P, a point on an outer peripheral surface of the first rotatable member where an absolute value of magnetic flux density of the third magnetic pole in a normal direction with respect to the outer peripheral surface of the first rotatable member is a maximum value is referred to as a point T, a point on an outer peripheral surface of the first rotatable member where an absolute value of magnetic flux density of the fourth magnetic pole in a normal direction with respect to the outer peripheral surface of the first rotatable member is a maximum value is referred to as a point R, and a point where a straight line passing the point P and a rotation center O of the first rotatable member intersects the outer peripheral surface of the first rotatable member is referred to as a point Q, the point Q is positioned downstream of the point T and upstream of the point R with respect to the rotational direction of the first rotatable member. An absolute value of maximum value of magnetic flux density of the third magnetic pole in a normal direction with respect to the outer peripheral surface of the first rotatable member is 1.2 times or more than an absolute value of maximum value of magnetic flux density of the fourth magnetic pole in a normal direction with respect to the outer peripheral surface of the first rotatable member.

According to a third aspect of the present disclosure, a developing apparatus includes a developing container including a first chamber configured to contain a developer including a toner and a carrier, and a second chamber partitioned from the first chamber by a partition wall, a first rotatable member to which the developer is supplied, the first rotatable member being configured to carry and feed the developer to a developing position where an electrostatic latent image formed on an image bearing member is developed, a first magnet provided non-rotatably and stationarily inside the first rotatable member, the first magnet having a first magnetic pole provided to face the image bearing member at the developing position, a second magnetic pole provided downstream of the first magnetic pole and adjacent to the first magnetic pole, with respect to a rotational direction of the first rotatable member and having a different magnetic polarity as that of the first magnetic pole, a third magnetic pole provided downstream of the second magnetic pole and adjacent to the second magnetic pole, with respect to the rotational direction of the first rotatable member, and having a different magnetic polarity as that of the second magnetic pole, a fourth magnetic pole provided downstream of the third magnetic pole and adjacent to the third magnetic pole, with respect to the rotational direction of the first rotatable member, and having a different magnetic polarity as that of the third magnetic pole, and a fifth magnetic pole provided downstream of the fourth magnetic pole and adjacent to the fourth magnetic pole, with respect to the rotational direction of the first rotatable member, and having a different magnetic polarity as that of the fourth magnetic pole, a second rotatable member disposed to face the first rotatable member and configured to receive the developer delivered from the first rotatable member by a magnetic field generated by the first magnet, the second rotatable member being configured to carry and feed the developer after developing the electrostatic latent image to collect the developer in the second chamber, a second magnet provided non-rotatably and stationarily inside the second rotatable member, the second magnet having a sixth magnetic pole having a different magnetic polarity as that of the fifth magnetic pole, wherein the developer after developing the electrostatic latent image is delivered from the first rotatable member to the second rotatable member by a magnetic field generated between the fifth magnetic pole and the sixth magnetic pole, and, a duct portion including a suction port and configured to extend downstream in the rotational direction of the first rotatable member from the suction port, the duct portion including a first duct wall disposed to face the second rotatable member, and a second duct wall disposed to face the first rotatable member, and also disposed to face the first duct wall and configured to form a space between the first duct wall through which air sucked in through the suction port flows, the second duct wall being positioned on an outer side than the first duct wall with respect to a rotation center of the second rotatable member in a radial direction of the second rotatable member. In a state where an edge of the second duct wall on the suction port side, which is an end point on the first rotatable member side, is referred to as a point P, a point on an outer peripheral surface of the first rotatable member where an absolute value of magnetic flux density of the third magnetic pole in a normal direction with respect to the outer peripheral surface of the first rotatable member is a maximum value is referred to as a point T, a point on an outer peripheral surface of the first rotatable member where an absolute value of magnetic flux density of the fourth magnetic pole in a normal direction with respect to the outer peripheral surface of the first rotatable member is a maximum value is referred to as a point R, and a point where a straight line passing the point P and a rotation center O of the first rotatable member intersects the outer peripheral surface of the first rotatable member is referred to as a point Q, the point Q is positioned downstream of the point T and upstream of the point R with respect to the rotational direction of the first rotatable member. In a state where a half-value width of a magnetic flux density of the third magnetic pole in a normal direction with respect to the outer peripheral surface of the first rotatable member where an absolute value of magnetic flux density of the third magnetic pole in a normal direction with respect to the outer peripheral surface of the first rotatable member is half the value of an absolute value of maximum value of magnetic flux density of the third magnetic pole in a normal direction with respect to the outer peripheral surface of the first rotatable member is referred to as BH1, and in a state where a half-value width of a magnetic flux density of the fourth magnetic pole in a normal direction with respect to the outer peripheral surface of the first rotatable member where an absolute value of magnetic flux density of the fourth magnetic pole in a normal direction with respect to the outer peripheral surface of the first rotatable member is half the value of an absolute value of maximum value of magnetic flux density of the fourth magnetic pole in a normal direction with respect to the outer peripheral surface of the first rotatable member is referred to as BH2, a difference between BH1 and BH2 is within a range of ±1°, and an absolute value of maximum value of magnetic flux density of the third magnetic pole in a normal direction with respect to the outer peripheral surface of the first rotatable member is equal to or greater than an absolute value of maximum value of magnetic flux density of the fourth magnetic pole in a normal direction with respect to the outer peripheral surface of the first rotatable member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a configuration of an image forming apparatus according to a first embodiment.

FIG. 2 is a schematic cross-sectional view illustrating a developing apparatus according to the first embodiment.

FIG. 3 is a view illustrating a magnetic pole arrangement of a first developing roller according to the first embodiment.

FIG. 4 is a view illustrating a magnetic pole arrangement of a second developing roller according to the first embodiment.

FIG. 5 is a view illustrating a magnetic pole arrangement of a peeling roller according to the first embodiment.

FIG. 6 is a cross-sectional view of a periphery of a second developing roller and a suction port of a duct according to the first embodiment.

FIG. 7A is a schematic diagram illustrating a relationship of forces acting on the carrier borne on the second developing roller, in a case where a direction of a magnetic force Fθ acting on the carrier is the same as a suction direction of the duct.

FIG. 7B is a schematic diagram illustrating a relationship of forces acting on a carrier borne on the second developing roller, in a case where the direction of the magnetic force Fθ acting on the carrier is opposite to the suction direction of the duct.

FIG. 8 is a graph illustrating a magnetic characteristic distribution acting on a carrier on a second sleeve according to a comparative example.

FIG. 9 is a graph illustrating a magnetic characteristic distribution acting on a carrier on the developing sleeve according to the first embodiment.

FIG. 10 is a graph indicating a range that absolute value of maximum value of normal component of magnetic flux density of each of a first feeding pole and a second feeding pole may take according to the first embodiment.

FIG. 11 is a graph indicating a magnetic characteristic distribution acting on a carrier on a developing sleeve according to a second embodiment.

FIG. 12 is a graph indicating a range that absolute value of maximum value of normal component of magnetic flux density of each of a first feeding pole and a second feeding pole may take according to the second embodiment.

### DESCRIPTION OF THE EMBODIMENTS

### First Embodiment

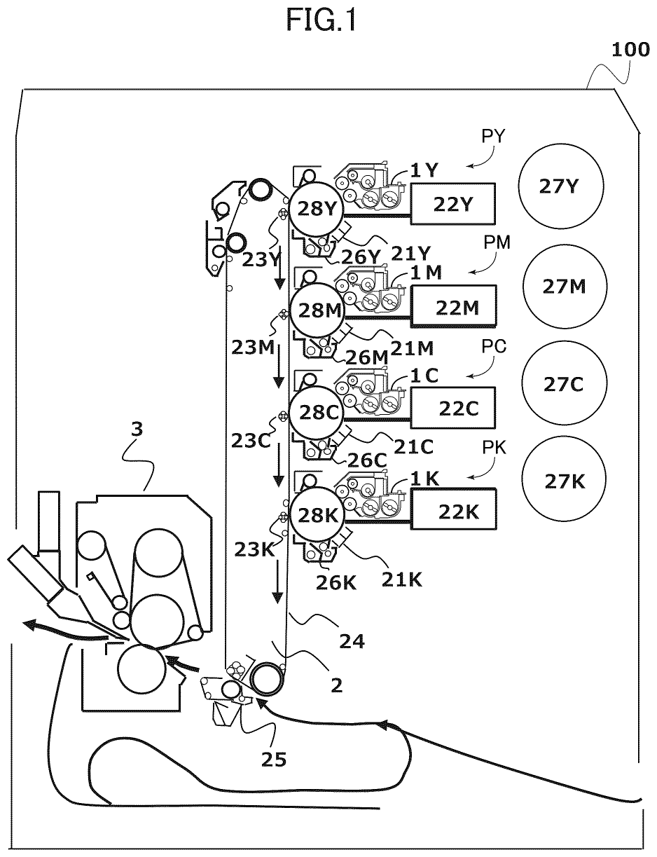

A first embodiment will be described with reference to FIGS. 1 to 10. First, a schematic configuration of an image forming apparatus of the present embodiment will be described with reference to FIG. 1.

### Image Forming Apparatus

An image forming apparatus 100 is a full-color image forming apparatus, and in the present embodiment, for example, is a multi-function peripheral (MFP) having a copy function, a printer function, and a scan function. As illustrated in FIG. 1, the image forming apparatus 100 includes image forming units PY, PM, PC, and PK that perform image forming processes for toner images of four colors of yellow, magenta, cyan, and black, respectively, that are arranged in parallel.

The image forming units PY, PM, PC, and PK of the respective colors include primary chargers 21Y, 21M, 21C, and 21K, developing apparatuses 1Y, 1M, 1C, and 1K, optical writing units (exposure devices) 22Y, 22M, 22C, and 22K, photosensitive drums 28Y, 28M, 28C, and 28K, and cleaning devices 26Y, 26M, 26C, and 26K. The image forming apparatus 100 includes a transfer device 2 and a fixing device 3. Since configurations of the image forming units PY, PM, PC, and PK of the respective colors are similar to each other, the image forming unit PY will be described below as a representative.

The photosensitive drum 28Y serving as an image bearing member is a photosensitive member including a photosensitive layer made of a resin such as a polycarbonate resin containing an organic photoconductor (OPC), and is configured to rotate at a predetermined speed. According to the present embodiment, a linear velocity of the surface of the photosensitive drum 28Y is set to 650 mm/s. The primary charger 21Y includes a corona discharge electrode disposed around the photosensitive drum 28Y, and charges the surface of the photosensitive drum 28Y with generated ions.

The optical writing unit 22Y incorporates a scanning optical device, and exposes the charged photosensitive drum 28Y based on image data to lower a potential of an exposed portion, thereby forming a charge pattern, i.e., electrostatic latent image, corresponding to the image data. The developing apparatus 1Y transfers a developer accommodated therein to the photosensitive drum 28Y to develop the electrostatic latent image formed on the photosensitive drum 28Y. The developer is formed by mixing a carrier and a toner corresponding to each color, and the electrostatic latent image is visualized by the toner.

The transfer device 2 includes primary transfer rollers 23Y, 23M, 23C, and 23K, an intermediate transfer belt 24, and a secondary transfer roller 25. The intermediate transfer belt 24 is wound around the primary transfer rollers 23Y, 23M, 23C, and 23K and a plurality of rollers, and is supported so as to be able to travel. The primary transfer rollers 23Y, 23M, 23C, and 23K correspond to respective colors of yellow (Y), magenta (M), cyan (C), and black (K) in order from the top in FIG. 1. The secondary transfer roller 25 is disposed outside the intermediate transfer belt 24, and is configured to allow a recording material to pass between the secondary transfer roller 25 and the intermediate transfer belt 24.

The toner images of the respective colors formed on the photosensitive drums 28Y, 28M, 28C, and 28K are sequentially transferred onto the intermediate transfer belt 24 by the operation of the primary transfer rollers 23Y, 23M, 23C, and 23K, and a color toner image in which layers of yellow, magenta, cyan, and black are superposed is formed. The formed toner image is transferred to a recording material conveyed by the secondary transfer roller 25 form a cassette accommodating the recording material. Pressure and heat are applied to the recording material on which the toner image is transferred at the fixing device 3. Thereby, the toner on the recording material is melted, and a color image is fixed on the recording material.

Developer storages 27Y, 27M, 27C, and 27K are respectively provided corresponding to the developing apparatuses 1Y, 1M, 1C, and 1K, and bottles accommodating developers corresponding to the respective colors of yellow, magenta, cyan, and black are replaceably loaded in the named order from the top. The developer storages 27Y, 27M, 27C, and 27K are configured to be able to convey, i.e., replenish, the developers to the developing apparatuses 1Y, 1M, 1C, and 1K corresponding to the colors of the accommodated developers.

For example, a weight ratio of the toner of the developer contained in the bottle is 80 to 95%, and a weight ratio of the toner of the developer in each of the developing apparatuses 1Y, 1M, 1C, and 1K is 5 to 10%. Therefore, once the toner is consumed to perform the development in the developing apparatuses 1Y, 1M, 1C, and 1K, the developer containing the toner is replenished to compensate for the amount of consumption, and the weight ratio of the toner of the developer in each of the developing apparatuses 1Y, 1M, 1C, and 1K is maintained constant.

### Developing Apparatus

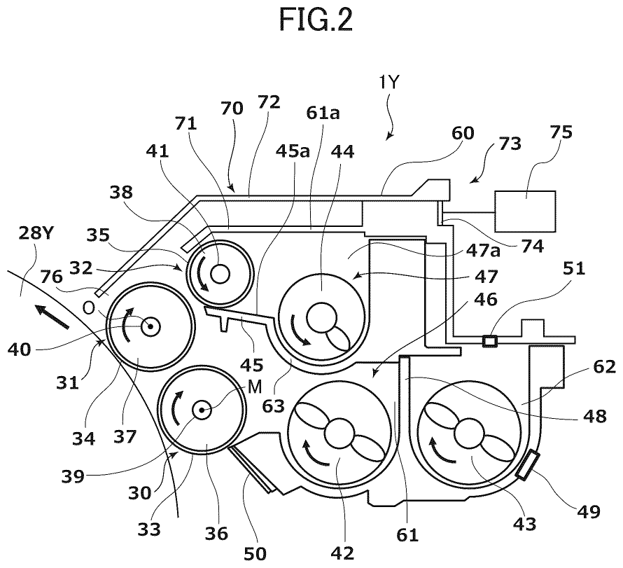

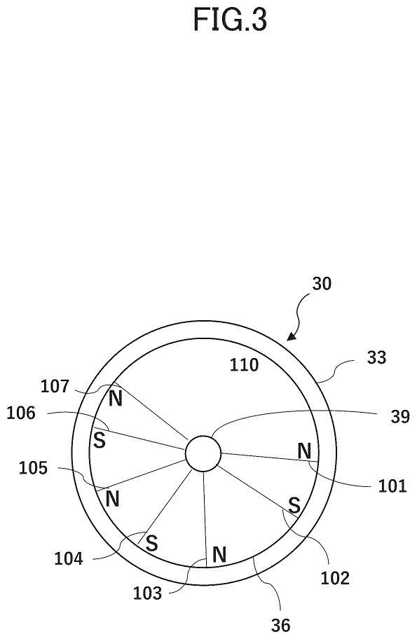

Next, the developing apparatuses 1Y, 1M, 1C, and 1K will be described in detail with reference to FIGS. 2 to 5. Since the configurations of the developing apparatuses 1Y, 1M, 1C, and 1K are the same, the developing apparatus 1Y will be described below as a representative. FIG. 2 is a conceptual view illustrating the developing apparatus 1Y illustrated in FIG. 1, and FIGS. 3, 4, and 5 are conceptual views illustrating magnetic pole configurations of a first magnet 36, a second magnet 37, and a third magnet 38 disposed in the developing apparatus 1Y.

As illustrated in FIG. 2, the developing apparatus 1Y includes a first developing roller 30, a second developing roller 31, a peeling roller 32, a developer supplying screw 42, a developer stirring screw 43, and a developer collecting screw 44, and these members are housed in a developing container 60.

The first developing roller 30 is a developer bearing member that is rotationally driven, and is disposed at a position adjacent to the photosensitive drum 28Y such that a rotational axis thereof is substantially parallel to a rotational axis of the photosensitive drum 28Y. The first developing roller 30 includes a first sleeve 33 serving as a first developing sleeve that rotates, and a first magnet (fixed magnet,) 36 serving as a first developing magnet that is provided non-rotatably inside the first sleeve 33 and attracts the developer to the surface of the first sleeve 33 by a magnetic force. Then, the first developing roller 30 attracts, i.e., carries, the developer from the developer supplying screw 42 based on the magnetic force, and develops the electrostatic latent image formed on the rotating photosensitive drum 28Y, i.e., on the image bearing member, with the developer.

Specifically, for example, a DC developing bias having a same polarity as a charging polarity of the primary charger 21Y, or a developing bias in which a DC voltage having a same polarity as the charging polarity of the primary charger 21Y is superposed to AC voltage, is applied to the first sleeve 33, and a second sleeve 34 described later, of the developing apparatus 1Y. As a result, reversal development is performed in which a toner charged to the same polarity as the charging polarity of the primary charger 21Y is adhered to the electrostatic latent image formed by the optical writing unit 22Y. In the present embodiment, a configuration is adopted in which a reversal development is performed where the charging polarity of the primary charger 21Y and the DC voltage of the developing bias are set to negative and a toner charged negatively is attached to the electrostatic latent image.

The first developing sleeve 33 is a nonmagnetic cylindrical member having an outer diameter of 25 mm (radius r1=12.5 mm), and is rotationally driven about a rotation shaft 39. A rotational direction of the first sleeve 33 is a clockwise direction as indicated by an arrow in FIG. 2, and is a direction opposite to a rotational direction of the photosensitive drum 28Y according to the present embodiment. Therefore, the first sleeve 33 and the photosensitive drum 28Y rotate in the same direction at positions facing each other. In the present embodiment, a linear velocity of the surface of the first sleeve 33 of the first developing roller 30 is set to be 1.0 times (=650 mm/s) the linear velocity of the surface of the photosensitive drum 28Y. Setting the ratio of linear velocity of the surface of the first sleeve 33 with respect to the linear velocity of the surface of the photosensitive drum 28Y to fall within approximately 1.0 times or more and 1.2 times or less is advantageous from the viewpoint of toner degradation. Meanwhile, the amount of toner being supplied to the photosensitive drum 28Y may be reduced and the image developing property may be deteriorated, but since the present embodiment is equipped with two developing rollers 30 and 31, the amount of toner being supplied to the photosensitive drum 28Y may be maintained even if the ratio of linear velocity is suppressed.

The first magnet 36 is disposed inside the first sleeve 33, and has a plurality of magnetic poles 101 to 107, as illustrated in FIG. 3. Solid lines of the magnetic poles 101 to 107 illustrated in FIG. 3 illustrate maximum value positions, i.e., peak positions or pole positions, of normal component distribution of magnetic flux density of the first magnet 36. A space that allows rotation of the first sleeve 33 is formed between an inner periphery of the first sleeve 33 and an outer periphery of the first magnet 36.

The developer attracted to the first sleeve 33 is fed toward the photosensitive drum 28Y by a rotation operation of the first sleeve 33, thereby developing the latent image formed on the photosensitive drum 28Y. After the latent image formed on the photosensitive drum 28Y is developed, the developer on the first sleeve 33 is fed to the vicinity of the second developing roller 31 by the rotation operation of the first sleeve 33. Then, in the vicinity of the closest position of the first developing roller 30 and the second developing roller 31, the developer is peeled off from the first sleeve 33 by a magnetic field generated by the first magnet 36 within the first developing roller 30 and the second magnet 37 within the second developing roller 31, and is delivered onto the second sleeve 34.

The second developing roller 31 of the developing apparatus 1Y according to the present embodiment is arranged above the first developing roller 30 in a vertical direction, as described below. Therefore, the transfer of developer from the first sleeve 33 to the second sleeve 34 is performed against gravity from down to up in the vertical direction. The first sleeve 33 and the second sleeve 34 are arranged with a gap of 3 mm therebetween at the closest portion.

The second developing roller 31 serving as a developing roller is a developer bearing member that is rotationally driven, is disposed downstream of the first developing roller 30 in the rotational direction of the photosensitive drum 28Y and positioned such that a rotation center O of the second developing roller 31 is arranged higher than a rotation center M of the first developing roller 30 in the vertical direction, and receives the developer delivered from the first developing roller 30 by magnetic force (FIG. 2). In the present embodiment, the entirety of the second developing roller 31 is positioned higher than the rotation center M of the first developing roller 30. Similar to the first developing roller 30, the second developing roller 31 is disposed at a position adjacent to the photosensitive drum 28Y such that a rotational axis thereof is substantially parallel to the rotational axis of the photosensitive drum 28Y. Therefore, the rotational axes of the second developing roller 31 and the first developing roller 30 are substantially parallel to each other.

The second developing roller 31 includes a second sleeve, i.e., second developing sleeve, 34 serving as a developing sleeve that rotates and a second magnet, i.e., second developing magnet or fixed magnet, 37 that is provided non-rotatably inside the second sleeve 34 and that serves as a developing magnet that attracts the developer to the surface of the second sleeve 34 by magnetic force. Then, the second developing roller 31 receives the developer delivered from the first developing roller 30, i.e., the first sleeve 33, based on the magnetic force, attracts, i.e., carries, the developer, and develops the electrostatic latent image formed on the rotating photosensitive drum 28Y with the developer. The peeling roller 32 described below is positioned on a side of the second developing roller 31.

The second sleeve 34 is a nonmagnetic cylindrical member having an outer diameter of 25 mm (radius r2=12.5 mm), and is rotationally driven about a rotation shaft 40. A rotational direction of the second sleeve 34 is a clockwise direction, similar to the first sleeve 33 as indicated by an arrow in FIG. 2, and is a direction opposite to the rotational direction of the photosensitive drum 28Y in the present embodiment. Therefore, the second sleeve 34 and the photosensitive drum 28Y rotate in the same direction at positions facing each other. Further, the second sleeve 34 and the first sleeve 33 rotate in opposite directions at positions facing each other. In the present embodiment, the linear velocity of the surface of the second sleeve 34 of the second developing roller 31 is set to be 1.2 times (=780 mm/s) the linear velocity of the surface of the photosensitive drum 28Y.

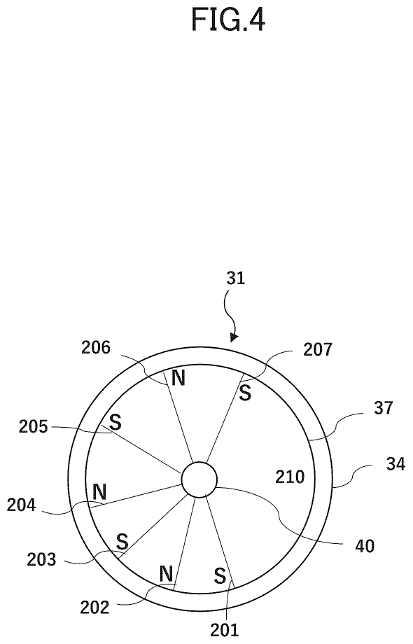

The second magnet 37 is disposed inside the second sleeve 34 and has a plurality of magnetic poles 201 to 207, as illustrated in FIG. 4. Solid lines of the magnetic poles 201 to 207 illustrated in FIG. 4 illustrate maximum value positions, i.e., peak positions or pole positions, of normal component distribution of magnetic flux density of the second magnet 37. A space that allows rotation of the second sleeve 34 is formed between an inner periphery of the second sleeve 34 and an outer periphery of the second magnet 37.

The developer attracted to the second sleeve 34 is fed toward the photosensitive drum 28Y by a rotation operation of the second sleeve 34, and develops the latent image formed on the photosensitive drum 28Y. After the latent image formed on the photosensitive drum 28Y is developed, the developer remaining on the second sleeve 34 is fed to the vicinity of the peeling roller 32 by the rotation operation of the second developing sleeve 34. Then, in the vicinity of the closest positions of the second developing roller 31 and the peeling roller 32, the developer is delivered from the second sleeve 34 to a third sleeve 35 of the peeling roller 32 by a magnetic field generated by the second magnet 37 within the second developing roller 31 and the third magnet 38 within the peeling roller 32.

The peeling roller, i.e., collecting roller, 32 serving as a peeling portion is disposed on a side opposite to the photosensitive drum 28Y with respect to a rotation center of the second sleeve 34, and peels, from the second developing roller 31, the developer after developing the electrostatic latent image on the photosensitive drum 28Y by the second developing roller 31. Specifically, the peeling roller 32 is a developer bearing member that is rotationally driven, and is disposed between the second developing roller 31 and the developer collecting screw 44 such that a rotation center thereof is positioned higher than the rotation center O of the second developing roller 31 in the vertical direction.

The peeling roller 32 is disposed such that a rotational axis thereof is substantially parallel to the rotational axis of the second developing roller 31. The peeling roller 32 includes the third sleeve 35 that serves as a peeling sleeve that rotates, and a third magnet, i.e., a peeling magnet or fixed magnet, 38 that is provided non-rotatably inside the third sleeve 35 and attracts the developer to the surface of the third sleeve 35 by magnetic force, and is configured to receive the developer delivered from the second developing roller 31 based on the magnetic force.

The third sleeve 35 is a nonmagnetic cylindrical member having an outer diameter of 18 mm (a radius of 9 mm), and is rotationally driven about a rotation shaft 41. A rotational direction of the third sleeve 35 is a counterclockwise direction as indicated by an arrow in FIG. 2, and is the opposite direction from the rotational direction of the second sleeve 34 in the present embodiment. Therefore, the third sleeve 35 and the second sleeve 34 rotate in the same direction at positions facing each other, i.e., opposing portions.

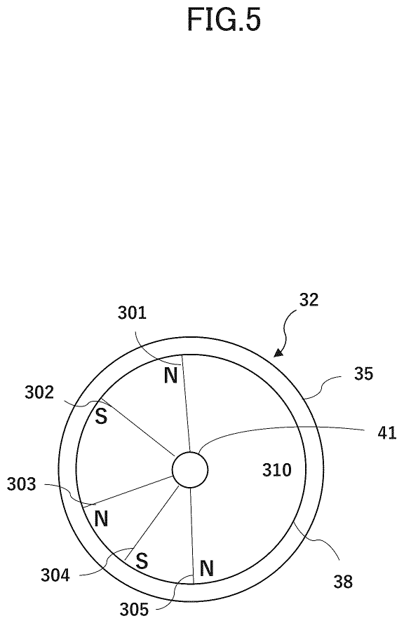

The third magnet 38 is disposed inside the third sleeve 35 and has a plurality of magnetic poles 301 to 305, as illustrated in FIG. 5. Solid lines of the magnetic poles 301 to 305 illustrated in FIG. 5 illustrate maximum value positions, i.e., peak positions or pole positions, of normal component distribution of magnetic flux density of the third magnet 38. A space that allows rotation of the third sleeve 35 is formed between an inner periphery of the third sleeve 35 and an outer periphery of the third magnet 38.

The developer attracted to the third sleeve 35, i.e., peeling sleeve, is fed downstream in the rotational direction by the rotation operation of the third sleeve 35, is peeled off from the third sleeve 35 by the third magnet 38 within the peeling roller 32 at a position close to the developer collecting screw 44, and falls toward a guide member 45 positioned lower in the vertical direction by its own weight. Then, the developer falling onto the guide member 45 is guided by its own weight toward the developer collecting screw 44.

The guide member 45 and the developer collecting screw 44 constitute a developer collecting portion 47 serving as a collecting portion that collects the developer peeled off from the third sleeve 35 of the peeling roller 32. In the developer collecting portion 47, the developer collecting screw 44 is positioned such that the rotation center thereof is arranged lower than the rotation center of the peeling roller 32 in the vertical direction, and conveys the developer delivered, i.e., collected, from the peeling roller 32 while stirring the developer.

The guide member 45 serving as a guide portion is disposed below the peeling roller 32 in the vertical direction, and guides the developer peeled off by the peeling roller 32 toward the developer collecting screw 44. The guide member 45 has an inclined surface 45a serving as a guide surface for guiding the developer peeled off from the peeling roller 32. The inclined surface 45a is inclined such that the developer slides thereon by its own weight in order to more reliably guide the peeled developer toward the developer collecting screw 44. The inclined surface 45a is inclined with respect to a horizontal direction such that a portion adjacent to the developer collecting screw 44, i.e., on the conveyance member side, is positioned lower than a closest position P2 with the peeling roller 32.

A developer collecting screw, i.e., conveyance screw, 44 serving as a conveyance member conveys the collected developer to a developer circulating portion 46 described below. That is, the developer collecting screw 44 is a screw conveyance member used to convey the developer sliding down the inclined surface 45a of the guide member 45 and collected in one direction while stirring the developer. Further, the rotational axis of the developer collecting screw 44 is arranged approximately in parallel with the rotational axis of the second sleeve 34, and the rotation center of the developer collecting screw 44 is positioned higher than the rotation center O of the second developing roller 31 in the vertical direction.

The developer circulating portion 46 is a supply portion for supplying the developer to the first developing roller 30, and the developer circulating portion 46 includes a regulating member 50, the developer supplying screw 42, and the developer stirring screw 43. In the developer circulating portion 46, the developer is supplied to the first developing roller 30 while being fed in the substantially horizontal direction and stirred by the developer supplying screw 42 and the developer stirring screw 43. As described above, the developer collected by the developer collecting portion 47 falls by its own weight and is introduced into the developer circulating portion 46.

The developer supplying screw 42, the developer stirring screw 43, and the developer collecting screw 44 are screw conveyance members that convey the developer in one direction while stirring the developer, and the developer supplying screw 42 and the developer stirring screw 43 are positioned lower than the developer collecting screw 44 in the vertical direction. In addition, the developer supplying screw 42, the developer stirring screw 43, and the developer collecting screw 44 are disposed such that rotation axes thereof are substantially parallel to each other. The rotation axis of each screw is substantially parallel to the rotation axis of the first developing roller 30.

The developer supplying screw 42 is positioned between the first developing roller 30 and the developer stirring screw 43, and a partition wall 48 of the developing container 60 is disposed between the developer supplying screw 42 and the developer stirring screw 43. The partition wall 48 of the developing container 60 extends in a rotation axis direction of the developer supplying screw 42 and the developer stirring screw 43. The partition wall 48 has a communication port (not illustrated) for communication between a first conveyance path (a first chamber) 61 through which the developer is fed by the developer supplying screw 42 and a second conveyance path 62 through which the developer is fed by the developer stirring screw 43.

The developer stirred by the developer collecting screw 44 passes through a communication port (not illustrated) formed in a partition wall 63 of the developing container 60 between a developer collecting chamber (a second chamber) 47a in which the developer collecting screw 44 is disposed and the first conveyance path (the first chamber) 61 in which the developer supplying screw 42 is disposed, and falls toward the developer supplying screw 42 by its own weight. The guide member 45 described above is formed integrally with the partition wall 63, and the developer collecting screw 44 is disposed above the partition wall 63.

A position of the communication port through which the developer stirred by the developer collecting screw 44 falls by its own weight and is introduced into the developer circulating portion 46 is preferably disposed to avoid a region where the developer is supplied toward the first developing roller 30, i.e., an intermediate portion of the developer supplying screw 42 in the rotation axis direction. In the present embodiment, it is assumed that the position of the communication port is a position within a range of a downstream end portion, i.e., terminal end portion, of the first conveyance path 61, in which the developer supplying screw 42 is disposed, in a developer conveyance direction.

The developer conveyance directions of the developer supplying screw 42 and the developer stirring screw 43 are opposite to each other. A start end side, i.e., an upstream end side in the developer conveyance direction, and a terminal end side, i.e., a downstream end side in the developer conveyance direction, of the first conveyance path 61 in which the developer supplying screw 42 is disposed communicate with a terminal end side and a start end side of the second conveyance path 62 in which the developer stirring screw 43 is disposed via the communication port provided in the partition wall 48. Therefore, the developer circulates in a rotational direction of the developer supplying screw 42 and the developer stirring screw 43 indicated by arrows in FIG. 2 and in the substantially horizontal direction inside the developing container 60, and a part of the developer is supplied toward the first developing roller 30.

A developer replenishment port 51 (refer to FIG. 2) is provided above the developer stirring screw 43 in the developing container 60, and is connected to the developer storage 27Y (refer to FIG. 1). The developer replenishment port 51 is configured to be able to replenish the developer contained in a bottle loaded in the developer storage 27Y to the second conveyance path 62 in which the developer stirring screw 43 is disposed.

As described above, since the weight ratio of the toner of the developer contained in the bottle of the developer storage 27Y is higher than the weight ratio of the toner of the developer in the developing apparatus 1Y, the weight ratio of the toner of the developer in the developing apparatus 1 can be maintained constant by adjusting the developer being replenished to the developer stirring screw 43.

A toner density detection sensor 49 (refer to FIG. 2) is provided to detect a toner density in the developer contained in the developer circulating portion 46. The toner density detection sensor 49 is a sensor that detects magnetic permeability of the developer. Since the toner density corresponds to the amount of toner consumption in the developing apparatus 1Y, the toner density is used for controlling developer replenishment from the developer storage 27Y. For example, when it is detected that the toner density is lower than a predetermined value, the developer is replenished from the developer storage 27Y. Since the magnetic permeability of the developer changes depending on the toner density, the toner density can be detected using the magnetic permeability.

The regulating member 50 is disposed adjacent to the first developing roller 30, and is used to regulate the amount of developer supplied from the developer circulating portion 46 to the first developing roller 30. For example, the regulating member 50 can be configured to regulate the amount of developer attracted to the first developing roller 30 based on a gap between the surface of the first sleeve 33 of the first developing roller 30 and an end portion of the regulating member 50.

In a developer circulation path in the developing container 60, the developer is fed in the substantially horizontal direction while being stirred in the developer circulating portion 46, is then supplied to the first developing roller 30, and is delivered from the first developing roller 30 to the second developing roller 31 positioned higher than the first developing roller 30 based on the magnetic force. Then, the developer is delivered again from the second developing roller 31 to the peeling roller 32 positioned on the side surface of the second developing roller 31 based on the magnetic force, is then peeled off from the peeling roller 32 by the third magnet 38 within the peeling roller 32, is further collected by the developer collecting portion 47, and is introduced again into the developer circulating portion 46.

As described above, in the present embodiment, a two-component developing system is used as a developing system, and a mixture of a nonmagnetic toner having a negative charging polarity and a magnetic carrier is used as the developer. The nonmagnetic toner is charged negatively by frictional electrification with the magnetic carrier, and the magnetic carrier is charged positively. The nonmagnetic toner is obtained by incorporating a colorant and a wax component in a resin such as a polyester resin or a styrene acrylic resin, pulverizing or polymerizing the resin into powder, and adding fine powder of titanium oxide, silica, or the like to the surface. The magnetic carrier is obtained by applying resin coating to a surface layer of a core formed of ferrite particles or resin particles kneaded with magnetic powder. A toner density, i.e., weight ratio of the toner contained in the developer, in the developer in an initial state is 8% in the present embodiment.

Note that the magnetic carrier preferably has a magnetization amount per unit weight of 40 Am²/kg or more and 80 Am²/kg or less in an applied magnetic field of 1000 oersted (79577 A/m). By reducing the magnetization amount of the magnetic carrier, an effect of suppressing scavenging by a magnetic brush is exerted, but adhesion of the magnetic carrier to the nonmagnetic sleeve by the magnet disposed in the developing roller becomes difficult, and image defects such as adhesion of the magnetic carrier to the photosensitive drum may occur. Scavenging is a phenomenon in which the magnetic carrier having completed the developing operation scrapes off the developed toner. When the magnetization amount of the magnetic carrier is larger than the above range, image defects may occur due to the pressure of the magnetic brush as described above. In the present embodiment, a magnetic carrier whose magnetization amount per unit weight is 63 Am²/kg is used.

The magnetization amount of the magnetic carrier was measured using a vibrating magnetic field-type automatic magnetic characteristic recording apparatus BHV-30 manufactured by RIKEN Denshi Co., Ltd. For a magnetic characteristic value of the magnetic carrier, an external magnetic field of 1000 oersted is created, and a strength of magnetization at that time is obtained. The magnetic carrier is packed in a cylindrical plastic container so as to be sufficiently dense. In this state, a magnetization moment is measured, the actual weight when a sample is put is measured, and the strength of magnetization (Am²/kg) is obtained.

A true specific gravity of the magnetic carrier is determined by a dry automatic density type AccuPyc 1330 manufactured by Shimadzu Corporation. In the present embodiment, a magnetic carrier having a true specific gravity, i.e., density, of 4.6 (g/cm³) was used. In addition, a magnetic carrier having a weight average diameter of 35 μm (radius b=17.5 μm) was used.

In general, in the two-component development method using a toner and a carrier, both the toner and the carrier are charged to predetermined polarities by being brought into frictional contact with each other, and thus has a feature that stress received by the toner is less than that of a one-component developing system using a one-component developer. On the other hand, the long-term use increases soiling, i.e., spent, attached to the surface of the carrier, and thus an ability to charge the toner gradually decreases. As a result, issues such as fogging and toner scattering occur. In order to prolong the life of a two-component developing apparatus, it is conceivable to increase the amount of carriers contained in the developing apparatus, but such a configuration is not desirable, since the size of the developing apparatus may be increased.

In order to solve the above issue related to the two-component developer, an auto carrier refresh (ACR) method is adopted in the present embodiment. The ACR method is a method of suppressing an increase in deteriorated carrier by replenishing a new developer from the developer storage 27Y into the developing apparatus 1Y little by little and discharging the developer with deteriorated charging performance little by little from a discharge port (not illustrated) of the developing apparatus 1Y. As a result, the deteriorated carrier in the developing apparatus 1Y is gradually replaced with the new carrier, and the charging performance of the carrier in the developing apparatus 1Y can be kept substantially constant.

### Magnetic Pole of Each Magnet

Next, the magnetic pole configurations of the first magnet 36, the second magnet 37, and the third magnet 38 within the first developing roller 30, the second developing roller 31, and the peeling roller 32 illustrated in FIGS. 3, 4, and 5 will be described.

As illustrated in FIG. 3, the first magnet 36 within the first developing roller 30 has a plurality of magnetic poles 101, 102, 103, 104, 105, 106, and 107, a total of seven magnetic poles. Among the magnetic poles, the magnetic pole 107 is a delivery pole for delivering the developer from the first developing roller 30 to the second developing roller 31. The magnetic poles 101 to 107 are arranged in number order in the rotational direction of the first sleeve 33. As described above, solid lines of the magnetic poles 101 to 107 illustrated in FIG. 3 indicate positions where a normal component Br of a magnetic flux density of the first magnet 36 with respect to the surface of the first sleeve 33, hereinafter may be simply referred to as “the magnetic flux density Br” or “the normal component Br”, has a peak value, i.e., maximum value. The same applies to the magnetic poles 201 to 207 of the second magnet 37 illustrated in FIG. 4 and the magnetic poles 301 to 305 of the third magnet 38 illustrated in FIG. 5.

The magnetic pole 107 serving as a delivery pole is a magnetic pole for delivering the developer from the first sleeve 33 to the second sleeve 34 by a magnetic field generated in cooperation with the second magnet 37 of the second developing roller 31, and hereinafter, the magnetic pole 107 may be referred to as a first delivery pole 107. The magnetic pole 101 is an N pole, and is used to attract the developer supplied from the developer supplying screw 42 onto the first sleeve 33. The magnetic poles 102, 103, 104, 105, and 106 are an S pole, an N pole, an S pole, an N pole, and an S pole, respectively, and are used to feed the developer attracted by the magnetic pole 101 upward as the first sleeve 33 rotates. The magnetic pole 107 is an N pole, and delivers the developer from the first sleeve 33 to the second sleeve 34 facing the first sleeve 33 by a magnetic field generated in cooperation with the magnetic pole 201 in the second magnet 37 within the second developing roller 31 as described above.

In the present embodiment, a low magnetic force portion 110 having a magnetic force lower than that of the first magnetic pole 107 is formed by a repulsive magnetic field generated in cooperation between the first delivery pole 107 and the magnetic pole 101 disposed downstream of the first delivery pole 107 in the rotational direction of the first sleeve 33 and having the same magnetic polarity as the first delivery pole 107. The low magnetic force portion 110 promotes delivery of the developer from the first sleeve 33 to the second developing sleeve 34. Note that the low magnetic force portion 110 has almost no magnetic force in the present embodiment, but may have a low magnetic force, and for example, may be a magnetic pole having a magnetic force, i.e., normal component Br of the magnetic flux density, of 5 mT or less. The same applies to a low magnetic force portion 210 of the second magnet 37 illustrated in FIG. 4 and a low magnetic force portion 310 of the third magnet 38 illustrated in FIG. 5.

Further, the magnetic pole 105 of the first magnet 36 is arranged to approximately face the photosensitive drum 28Y, and is a magnetic pole for developing the electrostatic latent image on the photosensitive drum 28Y. Hereinafter, the magnetic pole 105 may be referred to as a first developing pole 105. As described above, the first magnet 36 of the first developing roller 30 includes seven magnetic poles. The object of such configuration is to realize a high image quality. In order to realize a high image quality, it is preferable that a magnetic brush of the developer formed by the magnetic force of the first developing pole 105 facing the photosensitive drum 28Y is dense. In order to make the magnetic brush of the developer dense, the magnetic force of the first developing pole 105 is made strong. Thereby, the magnetic carrier within the developer is easily attracted to the surface of the first sleeve 33, and the magnetic brush may be made dense.

The magnetic force of the first developing pole 105 may be made strong by either increasing an absolute value of magnetic flux density of the first developing pole 105 or by increasing the variation, i.e., differential regarding distance, of magnetic flux density. In the present embodiment, a magnetic pole is arranged in a close region within 40° upstream and downstream of the first developing pole 105 by setting the absolute value of maximum value of the normal component Br of the magnetic flux density of the first developing pole 105 to 150 mT or greater and by setting the first magnet 36 to have seven magnetic poles. As a result, the magnetic force of the first developing pole 105 may be made great, and the magnetic brush becomes dense. Therefore, a high image quality may be realized. In the present embodiment, the magnetic pole 106, hereinafter referred to as a first developing downstream pole 106, is arranged adjacently between the first developing pole 105 and the first delivery pole 107 on a downstream side in a developer conveyance direction of the first developing pole 105, i.e., downstream in the rotational direction of the first sleeve 33. Further, the magnetic pole 104, hereinafter referred to as a first developing upstream pole 104, is arranged adjacently on an upstream side of the first developing pole 105 in the developer conveyance direction, i.e., upstream side of the first sleeve 33 in the rotational direction.

As illustrated in FIG. 4, the second magnet 37 inside in the second developing roller 31 includes a plurality of magnetic poles 201, 202, 203, 204, 205, 206, and 207, a total of seven magnetic poles. Among the magnetic poles, the magnetic pole 201 is a receiving pole for the second developing roller 31 to receive the developer from the first developing roller 30. The magnetic poles 201 to 207 are arranged in number order in the rotational direction of the second sleeve 34.

The magnetic pole 201 serving as the receiving pole is a magnetic pole for receiving and attracting the developer from the first sleeve 33 to the second sleeve 34 by the magnetic field generated in cooperation with the magnetic pole 107 of the first magnet 36 of the first developing roller 30, and hereinafter, the magnetic pole 201 may be referred to as a receiving pole 201. The magnetic pole 207 is a magnetic pole for delivering the developer from the second sleeve 34 to the third sleeve 35 by the magnetic field generated in cooperation with the third magnet 38 of the peeling roller 32.

Further, the receiving pole 201 is an S pole having a magnetic polarity different from that of the first delivery pole 107, and is used to attract the developer from the first developing roller 30, i.e., first sleeve 33, onto the second sleeve 34 as described above. The magnetic poles 202, 203, 204, 205, and 206 are an N pole, an S pole, an N pole, an S pole, and an N pole, respectively, and are used to feed the developer attracted by the magnetic pole 201 upward as the second sleeve 34 rotates. The magnetic pole 207 is an S pole, and delivers the developer having passed through a development region between the photosensitive drum 28Y corresponding to the magnetic pole 203 from the second sleeve 34 to the third sleeve 35 facing the second sleeve 34 by a magnetic field generated in cooperation with the magnetic pole 303 of the third magnet 38 within the peeling roller 32.

In the present embodiment, the low magnetic force portion 210 having a magnetic force lower than that of the magnetic pole 207 is formed by a repulsive magnetic field generated in cooperation between the receiving pole 201 and the magnetic pole 207 disposed upstream of the receiving pole 201 in the rotational direction of the second sleeve 34 and having the same magnetic polarity as the receiving pole 201. The low magnetic force portion 210 promotes delivery of the developer from the first sleeve 33 to the second sleeve 34. In addition, the low magnetic force portion 210 can prevent the developer from being attracted to the closest portions of the first sleeve 33 and the second sleeve 34, such that a pressure applied to the developer can be suppressed.

The magnetic pole 203 of the second magnet 37 of the second developing roller 31 is arranged approximately facing the photosensitive drum 28Y on a downstream side in the rotational direction of the photosensitive drum 28Y from the portion of the photosensitive drum 28Y facing the first developing pole 105. The magnetic pole 203 serving as a first magnetic pole is a magnetic pole for developing the electrostatic latent image on the photosensitive drum 28Y, and hereinafter, the magnetic pole 203 may be referred to as a second developing pole 203. In order to realize a high image quality, similar to the first magnet 36 of the first developing roller 30, the second magnet 37 of the second developing roller 31 also has an absolute value of maximum value of the normal component Br of magnetic flux density of the second developing pole 203 as high as 150 mT or more. In addition, by setting the second magnet 37 to include seven magnetic poles, the magnetic pole is arranged in a close region within 40° upstream and downstream of the second developing pole 203.

That is, a magnetic pole 202, hereinafter referred to as a second developing upstream pole 202, is disposed adjacent to and between the second developing pole 203 and the receiving pole 201 on an upstream side in the developer conveyance direction of the second developing pole 203, i.e., upstream side in the rotational direction of the second sleeve 34. That is, the position where the absolute value of magnetic flux density in the normal direction of the second developing upstream pole 202 becomes maximum is arranged within a range of 40° in the rotational direction of the second sleeve 34 with respect to the position where the absolute value of magnetic flux density in the normal direction of the second developing pole 203 becomes maximum. Further, a magnetic pole 204, hereinafter referred to as a second developing downstream pole 204, serving as a second magnetic pole is disposed adjacent to the second developing pole 203 on a downstream side in the developer conveyance direction, that is, downstream in the rotational direction of the second sleeve 34. That is, the position where the absolute value of magnetic flux density in the normal direction of the second developing downstream pole 204 becomes maximum is arranged within a range of 40° regarding the rotational direction of the second sleeve 34 with respect to the position where the absolute value of magnetic flux density in the normal direction of the second developing pole 203 becomes maximum.

The magnetic pole 205 and the magnetic pole 206 are arranged close to each other on a downstream side in the developer conveyance direction of the second developing downstream pole 204 serving as a second magnetic pole. That is, the magnetic pole 205 serving as a third magnetic pole is arranged adjacent to the second developing downstream pole 204 on a downstream side of the second developing downstream pole 204 with respect to the rotational direction of the second sleeve 34. The magnetic pole 205 has the same magnetic polarity as the second developing pole 203. Hereinafter, the magnetic pole 205 may be referred to as a first feeding pole 205. Further, the magnetic pole 206 serving as a fourth magnetic pole is arranged adjacent to the first feeding pole 205 on a downstream side of the first feeding pole 205 with respect to the rotational direction of the second sleeve 34. Hereinafter, the magnetic pole 206 may be referred to as a second feeding pole 206. Moreover, the magnetic pole 207 is arranged adjacent to the second feeding pole 206 on a downstream side of the second feeding pole 206 with respect to the rotational direction of the second sleeve 34. The magnetic pole 207 serving as a fifth magnetic pole is a magnetic pole for delivering the developer from the second developing roller 31 to the peeling roller 32, and hereinafter, the magnetic pole 207 may be referred to as a second delivery pole 207. The developer is moved on the second developing downstream pole 204, the first feeding pole 205, the second feeding pole 206, and the second delivery pole 207 along with the rotation of the second sleeve 34, and moves to the magnetic pole 303 by a magnetic field generated in cooperation with the third magnet 38 of the peeling roller 32.

As illustrated in FIG. 5, the third magnet 38 within the peeling roller 32 has the plurality of magnetic poles 301, 302, 303, 304, and 305. The magnetic poles 301 to 305 are arranged in number order in the rotational direction of the third sleeve 35.

The magnetic pole 303, which is an N pole that is of different polarity as the magnetic pole 207, is a magnetic pole for attracting the developer peeled from the second sleeve 34 to the third sleeve 35, and hereinafter, the magnetic pole 303 may be referred to as the receiving pole 303. The magnetic poles 301, 302, and 304 are an N pole, an S pole, and an S pole, respectively, and are used to feed the developer on the third sleeve 35 as the third sleeve 35 rotates. In particular, the magnetic pole 304 is a magnetic pole that conveys the developer attracted by the magnetic pole 303 downward along with the rotation of the third sleeve 35, and hereafter, the magnetic pole 304 may be referred to as a feeding pole 304. The magnetic pole 305 is an N pole, and is a magnetic pole for peeling the developer attracted to the third sleeve 35 from the third sleeve 35 by a repulsive magnetic field generated in cooperation with the magnetic pole 301 having the same magnetic polarity, and hereafter, the magnetic pole 305 may be referred to as a peeling pole 305.

### Suction Duct

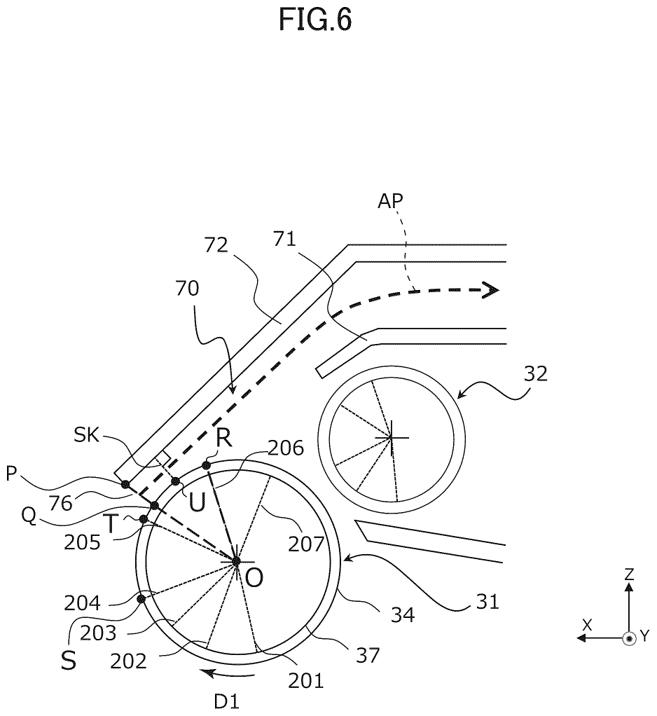

A configuration of a suction duct 70 will be described with reference to FIGS. 2 to 6. As illustrated in FIG. 6, a direction orthogonal to the rotational axis direction of the second sleeve and also orthogonal to the vertical direction is referred to as an X direction, a direction parallel to the rotational axis direction of the second sleeve is referred to as a Y direction, and a vertical direction is referred to as a Z direction.

The developing apparatus 1Y includes the suction duct 70 serving as a duct disposed above the second developing roller 31 and the peeling roller 32. The suction duct 70 sucks the developer that has been scattered above the second developing roller 31 and the peeling roller 32. The suction duct 70 includes a duct lower portion 71 serving as a first duct wall, a duct upper portion 72 serving as a second duct wall, a duct discharge port 73, and a toner collecting filter 74 (FIG. 2). The duct lower portion 71 is arranged above the peeling roller 32 so as to face a portion of the peeling roller 32 with a gap therebetween. The duct upper portion 72 is arranged such that a portion thereof faces the duct lower portion 71, and is extended further toward the second developing roller 31, i.e., toward the developing roller, than the duct lower portion 71, so as to face a portion of the second developing roller 31 with a gap therebetween. The duct upper portion 72 forms a space through which developer flows with a portion of the second developing roller 31 and the duct lower portion 71. The duct discharge port 73 is connected to the image forming apparatus body, and discharges the air sucked into the suction duct 70 from a suction port 76 by rotation of a fan 75 disposed in the image forming apparatus body,

Now, as illustrated in FIG. 6, a point where a line connecting the rotation center O of the second sleeve 34 and an edge P of the duct upper portion 72 on the second developing roller 31 side, hereinafter may be referred to as the duct upper portion end point P, crosses the surface of the second sleeve 34 is referred to as Q. In this case, the suction port 76 corresponds to an opening portion between the duct upper portion end point P and the point Q. Further, a flow path of the air sucked through the suction port 76 into the suction duct 70 is referred to as an airflow AP. By sucking the toner scattered in the developer conveyance passage on a downstream side in the rotational direction of the second sleeve 34 of the second developing pole 203, hereinafter referred to as scattered toner, using the airflow AP, the scattered toner may be suppressed from being attached to the developing apparatus 1Y or the image forming apparatus body. The scattered toner sucked in by the suction duct 70 is collected by the toner collecting filter 74.

The duct upper portion end point P is arranged between a normal line that extends from the surface of the second sleeve 34 where the normal component of magnetic flux density of the second developing downstream pole 204 becomes maximum and a normal line that extends from the surface of the second sleeve 34 where the normal component of magnetic flux density of the second feeding pole 206 becomes maximum. Now, the point Q is a point where the line connecting the duct upper portion end point P and the rotation center O crosses the surface of the second sleeve 34, as described above. A position where the absolute value of magnetic flux density in the normal direction of the second feeding pole 206 on the second sleeve 34 becomes maximum is referred to as R, and a position where the absolute value of magnetic flux density in the normal direction of the second developing downstream pole 204 on the second sleeve 34 becomes maximum is referred to as S. In this case, the point Q is positioned downstream of position S and upstream of position R with respect to the rotational direction of the second sleeve 34. Thereby, the scattered toner on the developer conveyance path on a downstream side of the second developing pole 203 can be sucked in preferably. In the present embodiment, the point Q is positioned downstream of a position T where the absolute value of magnetic flux density in the normal direction of the first feeding pole 205 on the second sleeve 34 becomes maximum with respect to the rotational direction of the second sleeve.

A more preferable arrangement of the duct upper portion end point P will be described. The scattered toner generated in the developer conveyance path on a downstream side of the second developing pole 203 with respect to the rotational direction of the second sleeve may be attached to the duct upper portion end point P, which is one end of the opening portion, in the process of being sucked into the suction duct 70. If such adhesion of scattered toner continues, the scattered toner may accumulate, and may fall by its own weight or by vibration at an unexpected timing. If the lump of accumulated scattered toner falls onto the surface of the second sleeve 34, the lump of accumulated scattered toner may enter the developer circulation path within the developing container 60, and may finally clog the regulating member 50. Thereby, developer on a portion of the first developing roller 30 and a portion of the second developing roller 31 may be lost, and stripe-like image defects may occur.

In order to prevent the occurrence of such image defects, it is preferable that the duct upper portion end point P is positioned close to the first feeding pole 205, and the line drawn downward in the Z direction, i.e., vertical direction, from the duct upper portion end point P does not overlap with the developer borne on the second developing roller 31. Thereby, even if the scattered toner accumulated in the vicinity of the duct upper portion end point P falls by its own weight or by vibration, the toner will not be attached to the second sleeve 34 and will be attached to the photosensitive drum 28Y, such that along with the rotation of the photosensitive drum 28Y, the lump of scattered toner that has fallen is eventually collected by a cleaning device 26Y.

Scattered toner is caused to occur by the mechanism described below. When the developer is left in a high-temperature and high-humidity environment, or deteriorates due to use, the amount of charge of toner drops, and the electrostatic adhesion force with the carrier becomes small. Then, centrifugal force by rotation of the second developing roller 31 and force in which the carrier is detached from the toner by the shock generated when the developer moves between magnetic poles of the second developing downstream pole 204, the first feeding pole 205, the second feeding pole 206, and the second delivery pole 207 become greater than the electrostatic adhesion force of the carrier and toner, by which scattered toner occurs.

Separation of Carrier from Second Developing Roller

In a configuration where scattered toner is sucked into the suction duct 70, not only scattered toner but also carrier particles may be sucked unintentionally from the developer on the second developing roller 31 exposed to the airflow AP. This phenomenon will be described below.

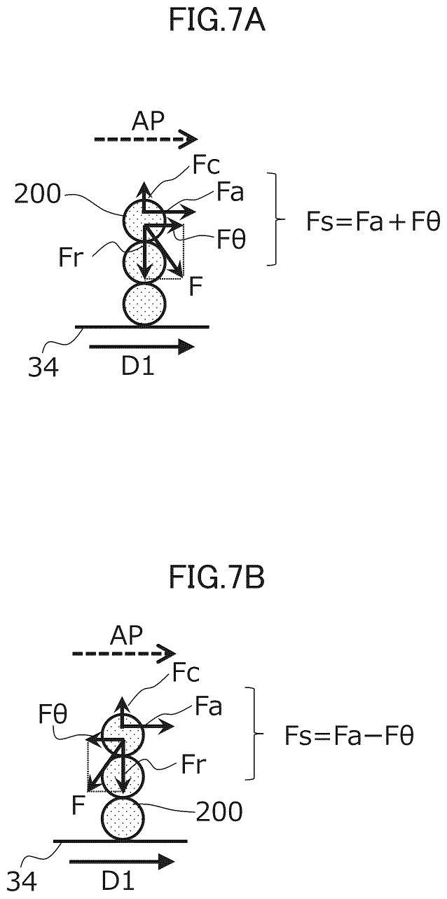

FIGS. 7A and 7B are schematic diagrams illustrating the force acting on the carrier borne on the second developing roller 31 exposed to the airflow AP. A magnetic force F caused by effects among magnetic poles disposed on the second magnet 37 act on carriers 200 borne on the surface of the second sleeve 34. The magnetic force F can be resolved into components of a magnetic force Fr in the normal direction of the second developing roller 31 and a magnetic force Fθ in a rotational direction D1 of the second sleeve 34. That is, the force Fr is a magnetic force component in the normal direction among the magnetic force F acting on the carrier on the second sleeve 34. Further, Fθ is a magnetic force component in the tangential direction among the magnetic force F acting on the carrier on the second sleeve 34. Further, the magnetic force Fr and a centrifugal force Fc caused by the rotation of the second sleeve 34 act in the normal direction of the second developing roller 31 on the carrier 200. In this state, if a coefficient of static friction between the carriers 200 or between the carrier 200 and the second sleeve 34 is referred to as μ, a maximum static friction force of the second sleeve 34 in the rotational direction will be Fm=μ(Fr−Fc).

Meanwhile, a force Fs acting on the carrier 200 in the rotational direction of the second sleeve 34 is a resultant force of a wind load Fa caused by wind pressure of the airflow AP and the magnetic force Fθ. In this state, if force Fs>maximum static friction force Fm is realized, there is a risk that the carrier 200 is separated from the second sleeve 34.

That is, as illustrated in FIG. 7A, if the direction of the magnetic force Fθ is the same direction as the wind load Fa that is caused by wind pressure of the airflow AP, i.e., the same direction as the rotational direction of the second sleeve 34, force Fs=wind load Fa+magnetic force Fθ is realized. Therefore, the force Fs becomes great compared to the maximum static friction force Fm, and the risk of separation of the carrier 200 from the second sleeve 34 is increased. The separated carrier 200 will be sucked in together with scattered toner by the airflow AP. The carrier 200 being sucked in unintentionally is collected together with the scattered toner by the toner collecting filter 74, which may cause clogging of the filter. Then, the suction force by the suction duct 70 is reduced, and scattered toner cannot be sucked in sufficiently, such that image defects may occur frequently.

Therefore, according to the present embodiment, as illustrated in FIG. 7B, the magnetic force Fθ is set to act in a direction opposite to the wind load Fa caused by wind pressure by the airflow AP, that is, in a direction opposite to the rotational direction of the second sleeve 34, such that force Fs=wind load Fa−magnetic force Fθ is realized, and the magnetic flux density of a plurality of magnetic poles arranged on the second magnet 37 is set so that the force Fs becomes small compared to the maximum static friction force Fm. Then, the separation of the carrier from the second sleeve 34 can be suppressed.

A magnetic flux density and a magnetic force F that the developing magnet create will be described below. In the description of the present embodiment, Br, Bθ, Fr, and Fθ are defined as follows.
Br: Magnetic flux density in a normal direction, i.e., vertical direction, with respect to an outer peripheral surface, i.e., surface, of the second sleeve 34 at a certain point
Bθ: Magnetic flux density in a tangential direction with respect to the outer peripheral surface of the second sleeve 34 at a certain point
Fr: Magnetic force applied in the normal direction with respect to the outer peripheral surface of the second sleeve 34 at a certain point
Fθ: Magnetic force applied in the tangential direction with respect to the outer peripheral surface of the second sleeve 34 at a certain point, wherein the rotational direction of the developing sleeve 11 is referred to as positive

Unless denoted otherwise, Br, Bθ, Fr, and Fθ refer to the magnetic flux density or the magnetic force at a certain point on the second sleeve 34.

### Method for Measuring Magnetic Force or Magnetic Flux Density

Next, a method for measuring a magnetic force according to the present embodiment will be described. The magnetic force according to the present embodiment can be calculated by a calculation method described below. The magnetic force acting on the carrier can be obtained by the following Expression (1). In the Expression, μ₀ represents the magnetic permeability of vacuum, u represents the magnetic permeability of the carrier, b represents the radius of the carrier, and B represents the magnetic flux density.

$$Expression ( 1 )$$

$$\vec{F} = \frac{μ - {μ}_{0}}{{μ}_{0} ( μ + 2 {μ}_{0} )} 2 π {b}^{3} ∇ {B}^{2} \qquad ( 1 )$$

Therefore,

$$Expression ( 2 )$$

$$\vec{F} ∝ ∇ {B}^{2} = \frac{\partial }{\partial r} ( {Br}^{2} + B {θ}^{2} ) {\vec{e}}_{r} + \frac{I}{r} \frac{\partial }{\partial θ ( {B}_{r}^{2} + {B}_{θ}^{2} )} {\vec{e}}_{θ} ∴ \vec{F} ∝ {\underbrace{( {B}_{r} \frac{\partial {B}_{r}}{\partial r} + {B}_{θ} \frac{\partial {B}_{θ}}{\partial r} ) {\vec{e}}_{r}}}_{Fr} + {\underbrace{\frac{I}{r} ( {B}_{r} \frac{\partial {B}_{r}}{\partial θ} + {B}_{0} \frac{\partial {B}_{θ}}{\partial θ} ) {\vec{e}}_{θ}}}_{F θ} \qquad ( 2 )$$

Based on Expression (2), Fr and Fθ can be calculated by acquiring Br and Bθ. The magnetic flux density Br was measured using a magnetic field measuring instrument “MS-9902” (Product Name) manufactured by F. W. BELL as the measuring instrument and setting the distance between a probe, which is a member of the measuring instrument, and the surface of the developing sleeve to approximately 100 μm.

Further, Bθ may be obtained by the following method. A vector potential A_{z} (R, θ) at a measurement position of the magnetic flux density Br can be obtained using the measured magnetic flux density Br by the following expression.

$$Expression ( 3 )$$

$${A}_{z} ( R , θ ) = {{\int }^{0}}_{0} RBrd θ \qquad ( 3 )$$

The boundary condition is set to A_{z} (R, θ), and A_{z} (r, θ) is obtained by solving the following expression,

$$∇ 2 {A}_{z} ( R , θ ) = 0$$

Then, Br and Bθ are obtained by the following expressions.

$$Expression ( 4 )$$

$${B}_{r} = \frac{I}{r} \frac{\partial {A}_{z} ( r , θ )}{\partial θ} \qquad ( 4 )$$

$$Expression ( 5 )$$

$${B}_{θ} = \frac{\partial {A}_{z} ( r , θ )}{\partial r} \qquad ( 5 )$$

Fr and Fθ may be obtained by applying Br and Bθ measured and calculated as described above to Expression (1). Further, based on the above Expression, the magnetic flux density distribution constituting the Fθ distribution that is required according to the present embodiment may be obtained.

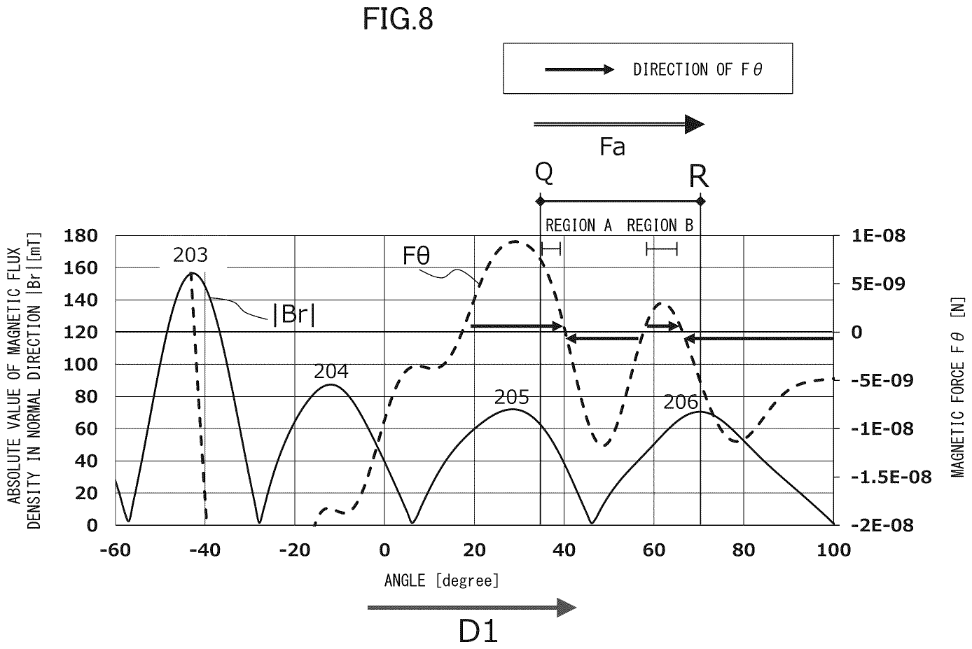

Next, the magnetic force Fθ acting on the carrier on the surface of the second sleeve 34 will be described. FIG. 8 illustrates a magnetic characteristic distribution of a comparative example in which an absolute value of the normal component Br of magnetic flux density in the vicinity of the magnetic poles 203, 204, 205, and 206 is shown by a solid line and the magnetic force Fθ composed of the magnetic poles arranged in the second magnet 37 is shown by a broken line. As for the sign of the magnetic force Fθ, a direction toward the same direction as the rotational direction D1 of the second sleeve 34 is referred to as positive, and the direction toward the opposite direction as the rotational direction of the second sleeve 34 is referred to as negative. The same applies to the subsequent drawings illustrating the magnetic characteristic distribution. The horizontal axis in FIG. 8 represents the magnetic pole positions of the respective magnetic poles 203, 204, 205, and 206 by angle in a case where a position of a point on the photosensitive drum 28Y side among points where a line extending in an X direction, i.e., horizontal direction, passing the rotation center O of the second sleeve 34 crosses the surface of the second sleeve 34 is set as 0° and the rotational direction of the second sleeve 34 is set as positive. As described above, the point Q is a point where the straight line connecting the rotation center O of the second sleeve 34 and the duct upper portion end point P crosses the surface of the second sleeve 34. As described above, the position R is a position on the surface of the second sleeve 34 where the absolute value of the normal component Br of magnetic flux density of the second feeding pole 206 becomes maximum.

The region that is exposed to the airflow AP and where separation of carrier from the second sleeve 34 may occur is a range from point Q to position R on the surface of the second sleeve 34. The air sucked into the suction duct 70 enters from an opening portion, i.e., the suction port 76, shown by the straight line connecting the duct upper portion end point P and the point Q, passes through the gap formed between the duct upper portion 72 and the second sleeve 34, and is flown to the flow path formed between the duct upper portion 72 and the duct lower portion 71. At a cross-section SK (FIG. 6) where the gap formed between the duct upper portion 72 and the second sleeve 34 becomes minimum, the cross-sectional area of the flow path becomes minimum, such that the flow speed is increased, and the wind load Fa becomes strongest.

Now, as illustrated in FIG. 6, a position U on the second sleeve 34 where it is closest to the duct upper portion 72 is positioned downstream of the position T where the absolute value of magnetic flux density in the normal direction of the first feeding pole 205 on the second sleeve 34 becomes maximum and upstream of the position R where the absolute value of magnetic flux density in the normal direction of the second feeding pole 206 on the second sleeve 34 becomes maximum, with respect to the rotational direction of the second sleeve 34. As described, since the second feeding pole 206 is arranged in the vicinity of the region where the wind load Fa becomes strongest, the developer moving from the first feeding pole 205 to the second feeding pole 206 along with the rotation of the second sleeve 34 is exposed to a strong wind load Fa.

At this time, depending on the magnetic force configuration of the first feeding pole 205 and the second feeding pole 206, the magnetic force Fθ may become positive between the first feeding pole 205 and the second feeding pole 206. In such a case, the wind load Fa and the magnetic force Fθ will be in the same direction, such that the risk of the carrier being separated from the second sleeve 34 will be increased. Therefore, the direction of the wind load Fa and the direction of the magnetic force Fθ are required to be opposite to each other from the point Q on the surface of the second sleeve 34, which is one end of the opening portion for sucking in air in the suction duct 70, to the position R on the surface of the second sleeve 34 where the absolute value of the normal component Br of magnetic flux density of the second feeding pole 206 becomes maximum.

The magnetic poles arranged in the second magnet 37 according to the comparative example will be described. As described above, by setting the absolute value of the maximum value, i.e., peak, of the normal component Br of magnetic flux density of the second developing pole 203 of the second developing roller 31 to 150 mT or greater, and arranging the second developing downstream pole 204 within 40° on the downstream side of the second developing pole 203 in the developer conveyance direction, the variation of magnetic flux density is increased with the intension of making the magnetic brush formed in the vicinity of the second developing pole 203 dense. The absolute value of maximum value of the normal component Br of magnetic flux density of the second developing downstream pole 204 is desirably 50% or more and 60% or less of the absolute value of maximum value of the normal component Br of magnetic flux density of the second developing pole 203, such that the influence of magnetic force of the second developing pole 203 acts strongly.

Further, along with the rotation of the second sleeve 34, the first feeding pole 205 and the second feeding pole 206 serve to move the developer on the surface of the second sleeve 34. It is preferable that the absolute value of maximum value of the normal component Br of magnetic flux density of the first feeding pole 205 is the same as or smaller than the absolute value of maximum value of the normal component Br of magnetic flux density of the second developing downstream pole 204. That is, the absolute value of maximum value of magnetic flux density of the first feeding pole 205 in the normal direction is preferably equal to or smaller than the absolute value of maximum value of magnetic flux density of the second developing downstream pole 204 in the normal direction. Thereby, smooth movement of the developer accompanying the rotation of the second sleeve 34 may be realized while reducing as much as possible the influence on the variation of magnetic flux density that occurs at the second developing pole 203 and the second developing downstream pole 204, as described above.

Further, the absolute value of maximum value of the normal component Br of the magnetic flux density of the second feeding pole 206 is set approximately equal to the absolute value of maximum value of the normal component Br of magnetic flux density of the first feeding pole 205. Thereby, the influence of magnetic force acting between magnetic poles of the first feeding pole 205 and the second feeding pole 206 is made even, and the movement of the developer accompanying the rotation of the second sleeve 34 is made smooth. Table 1 illustrates absolute values of maximum values of the normal components Br of magnetic flux densities of the magnetic poles 203, 204, 205, and 206 and angles thereof according to the comparative example. The angle of each magnetic pole is an angle of a case where a point on the photosensitive drum 28Y side between the points where the line extending in the X direction, i.e., horizontal direction, passing the rotation center O of the second sleeve 34 crosses the surface of the second sleeve 34 is set as 0° and the rotational direction of the second sleeve 34 is set as positive.

TABLE 1

| | SECOND DEVELOPING | | SECOND DEVELOPING | | FIRST FEEDING | | SECOND FEEDING | |
|---|---|---|---|---|---|---|---|---|
| | POLE 203 | | DOWNSTREAM POLE 204 | | POLE 205 | | POLE 206 | |
| | \|Br\| | ANGLE | \|Br\| | ANGLE | \|Br\| | ANGLE | \|Br\| | ANGLE |
| COMPARATIVE | 156 mT | −43º | 84 mT | −12º | 72 mT | 28 | 70 mT | 72° |
| EXAMPLE | | | | | | | | |

In the case of the comparative example having the magnetic pole configuration as described above, as illustrated in FIG. 8, a region where the magnetic force Fθ becomes positive is included in the range from the point Q to the position R on the surface of the second sleeve 34. Specifically, the magnetic force Fθ becomes positive in a region from angles 36° to 41°, hereinafter referred to as a region A, and in a region from angles 58° to 67°, hereinafter referred to as a region B. That is, in regions A and B, the directions of the wind load Fa and the magnetic force Fθ are the same, such that the carrier may be peeled from the second sleeve 34.

A phenomenon where the magnetic force Fθ becomes positive in the region A according to the comparative example will be described. The absolute value of maximum value of the normal component Br of magnetic flux density of the second developing pole 203 is as large as 156 mT, whereas the first feeding pole 205 is an S pole, which is the same magnetic pole as the second developing pole 203, but has an absolute value of maximum value of the normal component Br of magnetic flux density that is half or less of the value of the second developing pole 203. As described, if there is a deviation in maximum values of magnetic flux densities of the same magnetic poles, the influence of repulsive force from the second developing pole 203 is strong in the vicinity of the first feeding pole 205. In this case, the repulsive force acts in the same direction as the rotational direction of the second sleeve 34, such that in the region A, the magnetic force Fθ becomes positive.

Next, a phenomenon where the magnetic force Fθ becomes positive in the region B will be described. In the comparative example, the absolute values of maximum values of the normal components Br of magnetic flux densities of the first feeding pole 205 and the second feeding pole 206 are approximately the same. In general, the magnetic force tends to act in the direction where the magnetic flux density is great, such that when the absolute values of maximum values of the normal components Br of magnetic flux densities of adjacent magnetic poles are approximately the same, the magnetic force Fθ in the vicinity of the magnetic pole acts toward the position of maximum value, i.e., peak position, of magnetic flux density of the magnetic pole. Therefore, in the region B, the magnetic force acting toward the peak position of the normal component Br of magnetic flux density of the second feeding pole 206 is applied, such that Fθ becomes positive.

Suppression of Carrier Separation from Second Developing Roller

In a range from the point Q to the position R on the surface of the second sleeve 34, as a magnetic pole configuration in which the magnetic force Fθ is negative and not positive, in region A, it is effective to raise the absolute value of maximum value of the normal component Br of magnetic flux density of the first feeding pole 205 in order to reduce the effect of repulsive force from the second developing pole 203, and in region B, it is effective to lower the absolute value of maximum value of the normal component Br of magnetic flux density of the second feeding pole 206 in order to reduce the effect of magnetic force of the second feeding pole 206.

Based on the studies of the present inventors, it has been discovered that the magnetic force Fθ becomes negative in the range from the point Q to the position R on the surface of the second sleeve 34 by setting the absolute value of maximum value of the normal component Br of magnetic flux density of the first feeding pole 205 to be 1.2 times or more of the absolute value of maximum value of the normal component Br of magnetic flux density of the second feeding pole 206. Therefore, according to the present embodiment, the absolute value of maximum value of the magnetic flux density of the first feeding pole 205 in the normal direction is set to 1.2 times or more of the absolute value of maximum value of the magnetic flux density of the second feeding pole 206 in the normal direction. Then, the Fθ is negative in a state where a direction in which Fθ acts is opposite to the rotational direction of the second sleeve 34, the magnetic force Fθ is set to be negative in the range from the point Q to the position R.

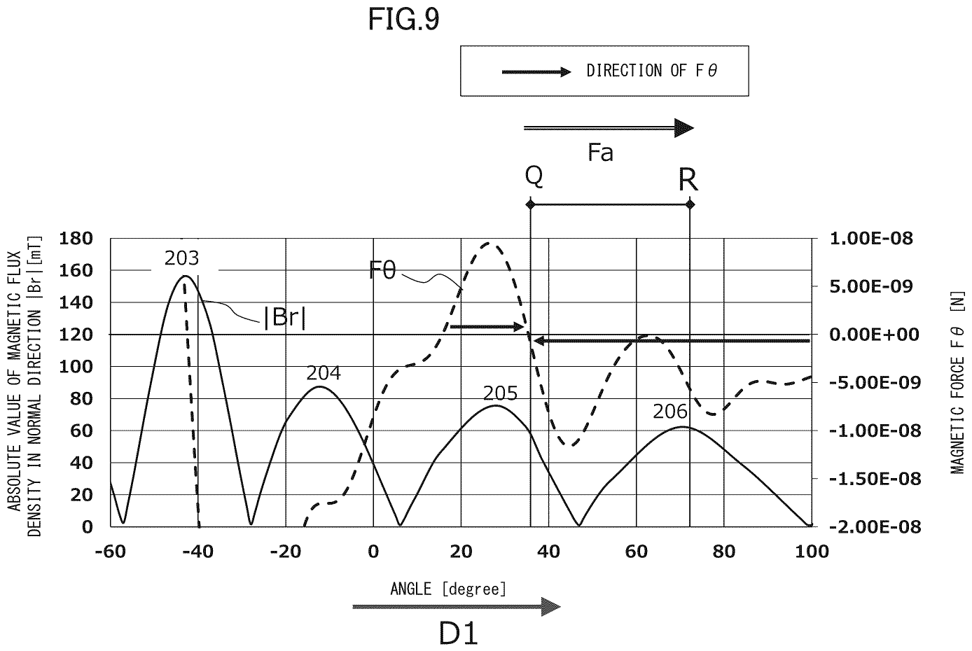

FIG. 9 illustrates a magnetic characteristic distribution in which an absolute value Br in the normal direction of magnetic flux density in the vicinity of the magnetic poles 203, 204, 205, and 206 according to the present embodiment is illustrated by a solid line, and the magnetic force Fθ composed of the magnetic poles disposed in the second magnet 37 is illustrated by a broken line. Table 2 illustrates absolute values of maximum values of the normal components Br of magnetic flux densities of the magnetic poles 203, 204, 205, and 206 and angles thereof according to Examples 1 to 3 that satisfy the present embodiment. The angle of each magnetic pole is an angle of a case where a point on the photosensitive drum 28Y side between the points where the line extending in the X direction, i.e., horizontal direction, passing the rotation center O of the second sleeve 34 crosses the surface of the second sleeve 34 is set as 0° and the rotational direction of the second sleeve 34 is set as positive, as described above. FIG. 9 illustrates a magnetic characteristic distribution of Example 1.

TABLE 2

| | SECOND DEVELOPING | | SECOND DEVELOPING | | FIRST FEEDING | | SECOND FEEDING | |
|---|---|---|---|---|---|---|---|---|
| | POLE 203 | | DOWNSTREAM POLE 204 | | POLE 205 | | POLE 206 | |
| | \|Br\| | ANGLE | \|Br\| | ANGLE | \|Br\| | ANGLE | \|Br\| | ANGLE |
| EXAMPLE 1 | 156 mT | −43º | 88 mT | −12º | 78 mT | 28° | 62 mT | 72° |
| EXAMPLE 2 | 156 mT | −43º | 88 mT | −12º | 48 mT | 28° | 40 mT | 72° |
| EXAMPLE 3 | 156 mT | −43º | 94 mT | −12º | 94 mT | 28° | 78 mT | 72° |

According to Example 1, the absolute value of maximum value of the normal component Br of magnetic flux density of the first feeding pole 205 is 78 mT, which is approximately 1.25 times the absolute value of maximum value of the normal component Br of magnetic flux density of the second feeding pole 206, which is 62 mT. This is a magnetic pole configuration in which the absolute value of maximum value of the normal component Br of magnetic flux density of the first feeding pole 205 is set higher than the comparative example while the absolute value of maximum value of the normal component of magnetic flux density of the second feeding pole 206 is set lower. Thereby, as illustrated in FIG. 9, the magnetic force Fθ is set to negative within the range from the point Q to the position R on the surface of the second sleeve 34 including the region A and the region B. As a result, the magnetic force Fθ will be in a direction opposite to the wind load Fa applied by wind pressure of the airflow AP as illustrated in FIG. 7B, such that the separation of carrier from the second sleeve 34 may be suppressed. Therefore, the absolute value of maximum value of magnetic flux density of the first feeding pole 205 in the normal direction is preferably set to 1.25 times or more of the absolute value of maximum value of magnetic flux density of the second feeding pole 206 in the normal direction.

Furthermore, based on the studies of the present inventors, it has been discovered that by maintaining the relationship of the absolute value of maximum value of the normal component Br of magnetic flux density of the first feeding pole 205 to be 1.2 time or more than the absolute value of maximum value of the normal component Br of magnetic flux density of the second feeding pole 206, the magnetic force Fθ will be negative in the range from the point Q to the position R on the surface of the second sleeve 34 even when the absolute values of maximum values of the normal components Br of magnetic flux densities of the first feeding pole 205 and the second feeding pole 206 are lowered compared to the comparative example. Specifically, it has been confirmed that by setting the lower limit value of the absolute value of maximum value of the normal component Br of magnetic flux density of the first feeding pole 205 to 48 mT and the lower limit value of the absolute value of maximum value of the normal component Br of magnetic flux density of the second feeding pole 206 to 40 mT, the magnetic force Fθ in the range from the point Q to the position R on the surface of the second sleeve 34 will be negative if the magnetic flux densities are greater than the above values. That is, it is preferable that the absolute value of maximum value of magnetic flux density of the second feeding pole 206 in the normal direction is set to 40 mT or more.

Example 2 of Table 2 illustrates an example in which the absolute values of maximum values of the normal components Br of magnetic flux densities of the first feeding pole 205 and the second feeding pole 206 are set to the lower limit values. By lowering the maximum values of the normal components Br of magnetic flux densities of the first feeding pole 205 and the second feeding pole 206 at the same time, the magnetic force acting within the region from the point Q to the position R on the surface of the second sleeve 34 is lowered entirely. Thereby, the magnetic force acting from the second developing downstream pole 204 which is an N pole toward the first feeding pole 205 which is an S pole is reduced, and instead, the magnetic force becomes strong between the magnetic poles of the second developing downstream pole 204 and the second developing pole 203. It is considered that as a result, the effect of the repulsive force acting on the first feeding pole 205 from the second developing pole 203 is reduced, and the magnetic force Fθ in the vicinity of the first feeding pole 205 becomes negative.

Furthermore, by maintaining the relationship of the absolute value of maximum value of the normal component Br of magnetic flux density of the first feeding pole 205 to be 1.2 times or more than the absolute value of maximum value of the normal component Br of magnetic flux density of the second feeding pole 206, it is considered that the effect of magnetic force of the second feeding pole 206 becomes small, and the magnetic force Fθ becomes negative even in the vicinity of the second feeding pole 206. Further, by setting the absolute value of maximum value of the normal component Br of magnetic flux density of the second feeding pole 206 to 40 mT or less, the movement of the developer accompanying the rotation of the second sleeve 34 will not be performed smoothly in the vicinity of the second feeding pole 206, such that it is required to ensure an absolute value of maximum value of the normal component Br of magnetic flux density of the second feeding pole 206 to be 40 mT or more.

Example 3 of Table 2 illustrates an example in which the absolute values of maximum values of the normal components Br of magnetic flux densities of the first feeding pole 205 and the second feeding pole 206 are set to the upper limit values. According to the present embodiment, as described above, by setting the absolute value of maximum value of the normal component Br of magnetic flux density of the second developing pole 203 to as large as 150 mT or more, and by arranging the second developing downstream pole 204 to be within 40° on the downstream side of the second developing pole 203 in the developer conveyance direction, the variation of magnetic flux density is increased, and the magnetic brush formed in the vicinity of the second developing pole 203 is made dense.

Furthermore, in order to enhance the influence of magnetic force of the second developing pole 203, the absolute value of maximum value of the normal component Br of magnetic flux density of the second developing downstream pole 204 is required to be suppressed to 60% the absolute value of maximum value of the normal component Br of magnetic flux density of the second developing pole 203 at maximum. The first feeding pole 205 positioned adjacent to the second developing downstream pole 204 downstream in the rotational direction of the second sleeve 34 is required to have the absolute value of maximum value of the normal component Br of magnetic flux density suppressed to approximately the same level as the second developing downstream pole 204 at maximum to realize smooth movement of the developer.

That is, the greatest possible value of the absolute value of maximum value of the normal component Br of magnetic flux density of the first feeding pole 205 is 94 mT in a case where the absolute value of the normal component Br of magnetic flux density of the second developing pole 203 is 156 mT. In this state, the absolute value of maximum value of the normal component Br of magnetic flux density of the second developing downstream pole 204 is also 94 mT. In a state where the absolute value of maximum value of the normal component Br of magnetic flux density of the first feeding pole 205 is 94 mT, by setting the absolute value of maximum value of the normal component Br of magnetic flux density of the second feeding pole 206 to 78 mT, the absolute value of maximum value of the normal component Br of magnetic flux density of the first feeding pole 205 will be 1.2 times or more than the absolute value of maximum value of the normal component Br of magnetic flux density of the second feeding pole 206. That is, the absolute value of maximum value of magnetic flux density of the first feeding pole 205 in the normal direction is preferably set to 94 mT or less.

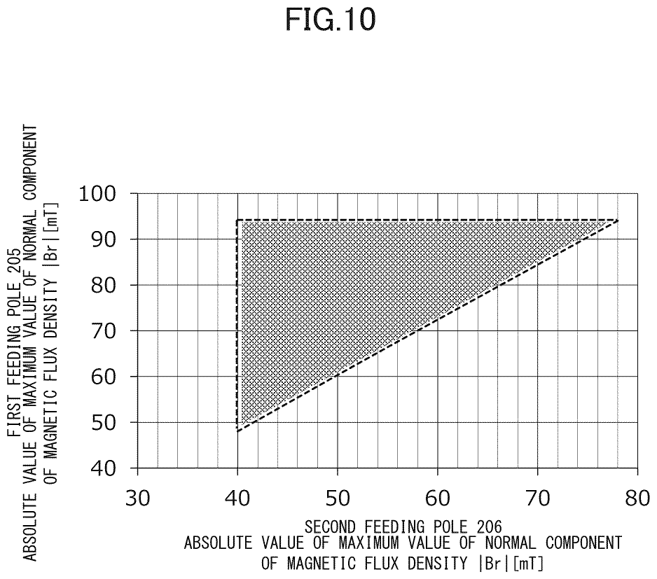

FIG. 10 illustrates a range that the absolute value of maximum value of the normal component Br of magnetic flux density of the first feeding pole 205 and the absolute value of maximum value of the normal component Br of magnetic flux density of the second feeding pole 206 may take to set the magnetic force Fθ to be negative within the range from the point Q to the position R on the surface of the second sleeve 34. A horizontal axis of FIG. 10 illustrates the absolute value of maximum value of the normal component Br of magnetic flux density of the second feeding pole 206, and a vertical axis thereof illustrates the absolute value of maximum value of the normal component Br of magnetic flux density of the first feeding pole 205. By setting the absolute value of maximum value of normal component of the magnetic flux density of each of the first feeding pole 205 and the second feeding pole 206 to fall within the region surrounded by the dotted line of FIG. 10, the magnetic force Fθ will be negative within the range from the point Q to the position R on the surface of the second sleeve 34.

The region surrounded by the dotted line of FIG. 10 is a range in which the absolute value of maximum value of the normal component Br of magnetic flux density of the first feeding pole 205 is 1.2 times or more than the absolute value of maximum value of the normal component Br of magnetic flux density of the second feeding pole 206, and in which 94 mT is set as the upper limit value of the absolute value of maximum value of the normal component Br of magnetic flux density of the first feeding pole 205 and 40 mT is set as the lower limit value of the absolute value of maximum value of the normal component Br of magnetic flux density of the second feeding pole 206.

Regarding the effect of suppressing the separation of carrier generated in the range from the point Q to the position R on the surface of the second sleeve 34, the comparative example and Examples 1 to 3 are compared. Table 3 illustrates a result of examining the presence or absence of carrier suction into the suction duct 70 with respect to the absolute values of maximum values of the normal components Br of magnetic flux densities of the first feeding pole 205 and the second feeding pole 206.

TABLE 3

| | FIRST | SECOND | | |
|---|---|---|---|---|
| | FEEDING | FEEDING | | CARRIER |
| | POLE 205 | POLE | MAGNIFI- | PRESENCE/ |
| | \| Br \| | 206\| Br \| | CATION | ABSENCE |
| COMPARATIVE | 72 mT | 70 mT | 1.03 TIMES | POOR |
| EXAMPLE | | | | |
| EXAMPLE 1 | 78 mT | 62 mT | 1.25 TIMES | GOOD |
| EXAMPLE 2 | 48 mT | 40 mT | 1.2 TIMES | AVERAGE |
| EXAMPLE 3 | 94 mT | 78 mT | 1.2 TIMES | AVERAGE |

The presence or absence of carrier suction is evaluated as follows. The number of carrier particles attached to the toner collecting filter 74 after forming 100 sheets of solid white images on A3 paper continuously was confirmed. The evaluation of carrier suction illustrated in Table 3 is as follows.
POOR: 100 or more carrier particles were attached to the toner collecting filter 74 after forming images on 100 sheets of A3 paper.
AVERAGE: Approximately 10 carrier particles were attached to the toner collecting filter 74 after forming images on 100 sheets of A3 paper.
GOOD: Approximately one carrier particle was attached to the toner collecting filter 74 after forming images on 100 sheets of A3 paper.

If the evaluation was “average” level or higher, it was determined that the target result regarding the suppression of carrier suction has been achieved. In the comparative example, the absolute value of maximum value of the normal component Br of magnetic flux density of the first feeding pole 205 is 1.03 times the absolute value of maximum value of the normal component Br of magnetic flux density of the second feeding pole 206. In such a magnetic force configuration, there was no effect of suppressing carrier suction. In Example 1, the absolute value of maximum value of the normal component Br of magnetic flux density of the first feeding pole 205 is 1.25 times the absolute value of maximum value of the normal component Br of magnetic flux density of the second feeding pole 206, and it can be recognized that the carrier suction is sufficiently suppressed. As for Example 2 and Example 3, the absolute value of maximum value of the normal component Br of magnetic flux density of the first feeding pole 205 is 1.2 times the absolute value of maximum value of the normal component Br of magnetic flux density of the second feeding pole 206, and the evaluations of presence or absence of carrier suction in these cases are recognized to achieve the “AVERAGE” level set as the target.

As described above, by setting the absolute value of maximum value of the normal component Br of magnetic flux density of the first feeding pole 205 to 1.2 times or more of the absolute value of maximum value of the normal component Br of magnetic flux density of the second feeding pole 206, the suction of carrier into the suction duct 70 can be suppressed. Since the collection of carrier by the suction duct 70 can be suppressed, the deterioration of suction force of the suction duct 70 caused by clogging of the toner collecting filter 74 can also be suppressed. As a result, the suction force of scattered toner can be maintained for a long time, and the generation of image defects may be suppressed.

### Second Embodiment

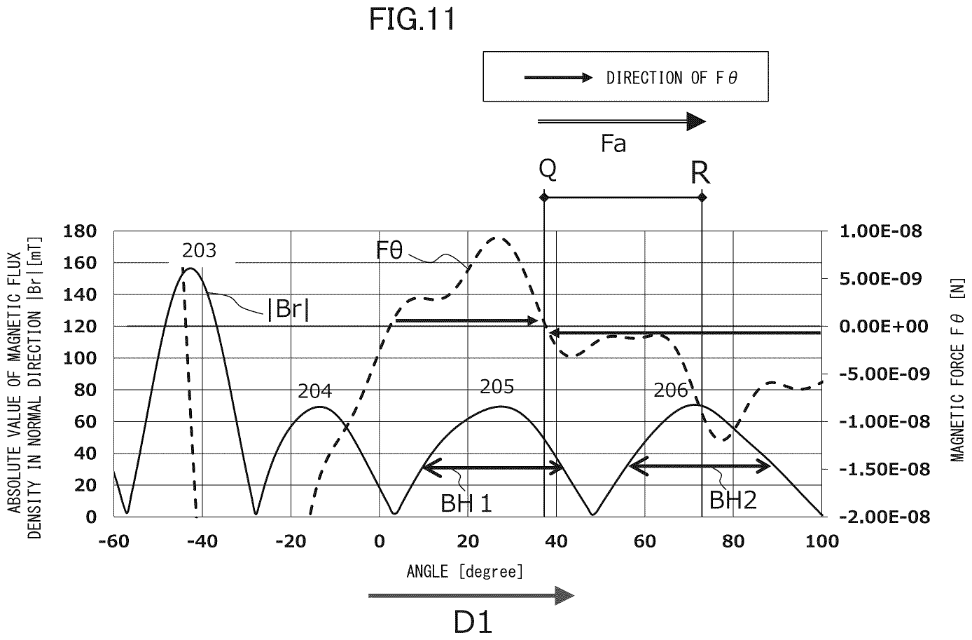

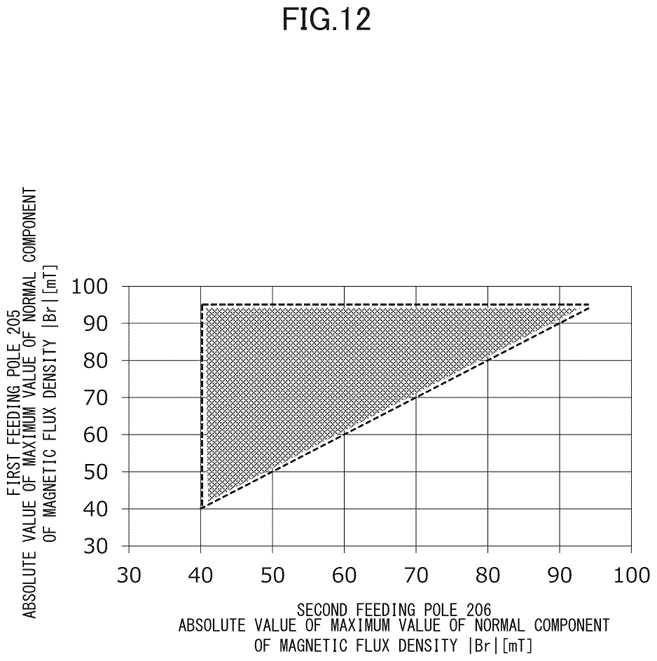

A second embodiment will be described with reference to FIGS. 11 and 12. The present embodiment differs from the first embodiment in the magnetic flux density configuration of a plurality of magnetic poles that are disposed non-rotatably on the second magnet 37 of the second developing roller 31. The other configurations and effects are the same as those of the first embodiment described above, such that similar component are denoted with the same reference numbers, and descriptions thereof are either omitted or simplified. In the following description, the points that differ from the first embodiment will mainly be described.

The first embodiment described above focused on the absolute values of maximum values of the normal components Br of magnetic flux densities of the first feeding pole 205 and the second feeding pole 206, which is a magnetic pole arranged adjacent thereto downstream in the direction of rotation of the second sleeve 34. One basis of the magnetic pole configuration acting on the magnetic force Fθ within the range from the point Q to the position R on the surface of the second sleeve 34 is a half-value width of magnetic flux densities of the first feeding pole 205 and the second feeding pole 206. The half-value width of magnetic flux density refers to a width of the position where the normal component of magnetic flux density becomes half a value with respect to a position where the normal component Br of magnetic flux density of the magnetic pole becomes maximum. In other words, half-value width represents the width represented by angle of a portion where the normal component Br of magnetic flux density of each magnetic pole becomes half the maximum value. It is sometimes called full width at half maximum to differentiate from half width at half maximum, but in the present specification, the term half-value width is meant to refer to full width at half maximum.

Based on the studies of the inventors, it has been discovered that, if a half-value width BH1 regarding the maximum value of the normal component Br of magnetic flux density of the first feeding pole 205 and a half-value width BH2 regarding the maximum value of the normal component Br of magnetic flux density of the second feeding pole 206 are set to be approximately the same level, the magnetic force Fθ will be negative within the range from the point Q to the position R on the surface of the second sleeve 34 by setting the absolute value of maximum value of the normal component Br of magnetic flux density of the first feeding pole 205 to be equal to or greater than the absolute value of maximum value of the normal component Br of magnetic flux density of the second feeding pole 206.

What is meant by the half-value width BH1 and the half-value width BH2 being approximately the same level is that, in a case where the half-value width BH1 and the half-value width BH2 are the same, it includes a case where the half-value width BH1 is both 1° greater than and 1° smaller than the half-value width BH2. That is, if the difference between BH1 and BH2 is within a range of ±1°, it is assumed that the half-value width BH1 and the half-value width BH2 are approximately the same level. Therefore, in the present embodiment, the difference between BH1 and BH2 is within the range of ±1°, and the absolute value of maximum value of magnetic flux density of the first feeding pole 205 in the normal direction is equal to or greater than the absolute value of maximum value of magnetic flux density of the second feeding pole 206 in the normal direction.

FIG. 11 illustrates a magnetic characteristic distribution in which the absolute value of the normal component Br of magnetic flux density in the vicinity of the magnetic poles 203, 204, 205, and 206 is illustrated by a solid line, and the magnetic force Fθ composed of the magnetic poles disposed in the second magnet 37 is illustrated by a broken line in a case where the half-value width BH1 and the half-value width BH2 are set to 30° and the absolute values of maximum values of the normal component Br of magnetic flux density of the first feeding pole 205 and the second feeding pole 206 are set to 70 mT. Based on FIG. 11, it can be recognized that the magnetic force Fθ is negative within the range from the point Q to the position R on the surface of the second sleeve 34.

FIG. 12 illustrates a range in which the absolute value of maximum value of the normal component Br of magnetic flux density of the first feeding pole 205 and the absolute value of maximum value of the normal component Br of magnetic flux density of the second feeding pole 206 may take to set the magnetic force Fθ to be negative within the range from the point Q to the position R on the surface of the second sleeve 34. A horizontal axis of FIG. 12 illustrates the absolute value of maximum value of the normal component Br of magnetic flux density of the second feeding pole 206, and a vertical axis thereof illustrates the absolute value of maximum value of the normal components Br of magnetic flux densities of the first feeding pole 205. By setting the absolute value of maximum value of normal component of the magnetic flux density of each of the first feeding pole 205 and the second feeding pole 206 to fall within the region surrounded by the dotted line of FIG. 12, the magnetic force Fθ will be negative within the range from the point Q to the position R on the surface of the second sleeve 34.

The region surrounded by the dotted line of FIG. 12 is a range in which the absolute value of maximum value of the normal component Br of magnetic flux density of the first feeding pole 205 is equal to or greater than the absolute value of maximum value of the normal component Br of magnetic flux density of the second feeding pole 206, and in which 94 mT is set as the upper limit value of the absolute value of maximum value of the normal component Br of magnetic flux density of the first feeding pole 205 and 40 mT is set as the lower limit value of the absolute value of maximum value of the normal components Br of magnetic flux densities of the second feeding pole 206. The upper limit of maximum value of the normal component Br of magnetic flux density of the first feeding pole 205 and the lower limit of maximum value of the normal component Br of magnetic flux density of the second feeding pole 206 are the same as the range illustrated in the first embodiment.

The effect of suppressing the separation of carrier generated in the range from the point Q to the position R on the surface of the second sleeve 34 according to the second embodiment is illustrated in Table 4. Table 4 illustrates a result of examining the presence or absence of carrier suction into the suction duct 70 with respect to the absolute values of maximum values of the normal components Br of magnetic flux densities of the first feeding pole 205 and the second feeding pole 206 and the half-value widths of magnetic flux densities thereof, according to a comparative example and Examples 4 to 6 that satisfy the present embodiment. The reference for evaluation and the target capability are the same as those illustrated according to the first embodiment.

TABLE 4

| | FIRST | | SECOND | | |
|---|---|---|---|---|---|
| | FEEDING | | FEEDING | | |
| | POLE 205 | | POLE 206 | | |
| | | HALF- | | HALF- | |
| | | VALUE | | VALUE | CARRIER |
| | | WIDTH | | WIDTH | PRESENCE/ |
| | \| Br \| | BH | \| Br \| | BH | ABSENCE |
| COMPARATIVE | 72 mT | 26° | 70 mT | 30° | POOR |
| EXAMPLE | | | | | |
| EXAMPLE 4 | 62 mT | 30° | 62 mT | 30° | GOOD |
| EXAMPLE 5 | 40 mT | 30° | 40 mT | 30° | AVERAGE |
| EXAMPLE 6 | 94 mT | 30° | 94 mT | 30° | AVERAGE |

According to the magnetic force configuration of the comparative example, the absolute values of maximum values of the normal components Br of magnetic flux densities of the first feeding pole 205 and the second feeding pole 206 are approximately the same, but the half-value width of magnetic flux density is wider according to the second feeding pole 206 than that of the first feeding pole 205. According to such configuration, the influence of the magnetic force of the second feeding pole 206 becomes strong, such that as illustrated in FIG. 8, there is a region where the magnetic force Fθ becomes positive within the range from the point Q to the position R on the surface of the second sleeve 34. Therefore, in the comparative example, the evaluation of presence or absence of suction of the carrier is “poor”.

Example 4, Example 5, and Example 6 adopt magnetic force configurations in which the absolute values of maximum values of the normal component Br of magnetic flux density of the first feeding pole 205 and the second feeding pole 206 are the same and the half-value widths thereof are also the same. It can be recognized that the suction of carrier has not occurred in Example 4. According to Example 5, the absolute values of maximum values of the normal components Br of the magnetic flux densities of the first feeding pole 205 and the second feeding pole 206 are set to the lower limit. Even according to this case, it can be recognized that the evaluation of presence or absence of carrier suction has achieved the “average” set as target. Further, according to Example 6, the absolute values of maximum values of the normal components Br of magnetic flux densities of the first feeding pole 205 and the second feeding pole 206 are set to the upper limit, and even according to this case, it can be recognized that the evaluation of presence or absence of carrier suction has achieve the “average” set as target.

As described above, by setting the half-value width BH1 of magnetic flux density of the first feeding pole 205 and the half-value width BH2 of magnetic flux density of the second feeding pole 206 to approximately the same level, and by setting the absolute value of maximum value of the normal component Br of magnetic flux density of the first feeding pole 205 to be equal to or greater than the absolute value of maximum value of the normal component Br of magnetic flux density of the second feeding pole 206, the magnetic force Fθ can be set to negative in the range from the point Q to the position R on the surface of the second sleeve 34. Therefore, the suction of carrier into the suction duct 70 can be suppressed. Since the collection of carrier into the suction duct 70 can be suppressed, the deterioration of suction force of the suction duct 70 caused by clogging of the toner collecting filter 74 can also be suppressed. As a result, the suction force for scattered toner may be maintained for a long time, and the generation of image defects may be suppressed.

### OTHER EMBODIMENTS

The present disclosure is not limited to the configurations of the respective embodiments described above. For example, the image forming apparatus 100 is not limited to the MFP, and may be a copying machine, a printer, or a facsimile device. Further, the configurations of the developer supplying screw 42, the developer stirring screw 43, and the developer collecting screw 44 are not specifically limited as long as the developer may be conveyed, and for example, a spiral blade or a paddle-like blade may be adopted.

The embodiments described above illustrated a configuration where the first developing roller 30 is arranged upstream and the second developing roller 31 is arranged downstream with respect to the rotational direction of the photosensitive drum 28Y, but a similar effect may be achieved in a state where the second developing roller 31 is arranged upstream and the first developing roller 30 is arranged downstream.

The embodiments described above illustrated a configuration where there are two developing rollers, which are the first developing roller 30 and the second developing roller 31, for developing the electrostatic latent image on the photosensitive drum, but the present disclosure is also applicable to a configuration in which only one developing roller is arranged.

According to the present disclosure, suction of carrier into the duct portion can be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-225246, filed Dec. 20, 2024, which is hereby incorporated by reference herein in its entirety.

What is claimed is:

1. A developing apparatus comprising:
a developing container including a first chamber configured to contain a developer including a toner and a carrier, and a second chamber partitioned from the first chamber by a partition wall;
a first rotatable member to which the developer is supplied, the first rotatable member being configured to carry and feed the developer to a developing position where an electrostatic latent image formed on an image bearing member is developed;
a first magnet provided non-rotatably and stationarily inside the first rotatable member, the first magnet having a first magnetic pole provided to face the image bearing member at the developing position, a second magnetic pole provided downstream of the first magnetic pole and adjacent to the first magnetic pole, with respect to a rotational direction of the first rotatable member and having a different magnetic polarity as that of the first magnetic pole, a third magnetic pole provided downstream of the second magnetic pole and adjacent to the second magnetic pole, with respect to the rotational direction of the first rotatable member, and having a different magnetic polarity as that of the second magnetic pole, a fourth magnetic pole provided downstream of the third magnetic pole and adjacent to the third magnetic pole, with respect to the rotational direction of the first rotatable member, and having a different magnetic polarity as that of the third magnetic pole, and a fifth magnetic pole provided downstream of the fourth magnetic pole and adjacent to the fourth magnetic pole, with respect to the rotational direction of the first rotatable member, and having a different magnetic polarity as that of the fourth magnetic pole;
a second rotatable member disposed to face the first rotatable member and configured to receive the developer delivered from the first rotatable member by a magnetic field generated by the first magnet, the second rotatable member being configured to carry and feed the developer after developing the electrostatic latent image to collect the developer in the second chamber;
a second magnet provided non-rotatably and stationarily inside the second rotatable member, the second magnet having a sixth magnetic pole having a different magnetic polarity as that of the fifth magnetic pole, wherein the developer after developing the electrostatic latent image is delivered from the first rotatable member to the second rotatable member by a magnetic field generated between the fifth magnetic pole and the sixth magnetic pole; and
a duct portion including a suction port and configured to extend downstream in the rotational direction of the first rotatable member from the suction port, the duct portion including a first duct wall disposed to face the second rotatable member, and a second duct wall disposed to face the first rotatable member, and also disposed to face the first duct wall and configured to form a space between the first duct wall through which air sucked in through the suction port flows, the second duct wall being positioned on an outer side than the first duct wall with respect to a rotation center of the second rotatable member in a radial direction of the second rotatable member,
wherein,
in a state where an edge of the second duct wall on the suction port side, which is an end point on the first rotatable member side, is referred to as a point P,
a point on an outer peripheral surface of the first rotatable member where an absolute value of magnetic flux density of the third magnetic pole in a normal direction with respect to the outer peripheral surface of the first rotatable member is a maximum value is referred to as a point T,
a point on an outer peripheral surface of the first rotatable member where an absolute value of magnetic flux density of the fourth magnetic pole in a normal direction with respect to the outer peripheral surface of the first rotatable member is a maximum value is referred to as a point R,
a point on an outer peripheral surface of the first rotatable member closest to the second duct wall is referred to as a point U, and
a point where a straight line passing the point P and a rotation center O of the first rotatable member intersects the outer peripheral surface of the first rotatable member is referred to as a point Q,
the point Q is positioned downstream of the point T and upstream of the point R with respect to the rotational direction of the first rotatable member,
the point U is positioned downstream of the point Q and upstream of the point R with respect to the rotational direction of the first rotatable member, and
wherein,
in a state where a magnetic force in a tangential direction with respect to the outer peripheral surface of the first rotatable member among the magnetic force acting on a carrier on the outer peripheral surface of the first rotatable member is referred to as Fθ,
a sign of the Fθ is positive in a state where a direction of the Fθ is a same direction as the rotational direction of the first rotatable member, and
a sign of the Fθ is negative in a state where a direction of the Fθ is an opposite direction as the rotational direction of the first rotatable member,
Fθ<0 is satisfied across a range from the point Q to the point U with respect to the rotational direction of the first rotatable member.

2. The developing apparatus according to claim 1, wherein
Fθ<0 is satisfied across a range from the point Q to the point R with respect to the rotational direction of the first rotatable member.

3. The developing apparatus according to claim 1, wherein
in a state where a position on the outer peripheral surface of the first rotatable member where an absolute value of magnetic flux density of the second magnetic pole in a normal direction with respect to the outer peripheral surface of the first rotatable member is a maximum value is referred to as a position S,
the point T is positioned downstream of the position S and upstream of the point Q with respect to the rotational direction of the first rotatable member.

4. The developing apparatus according to claim 1, wherein
an absolute value of maximum value of magnetic flux density of the third magnetic pole in a normal direction with respect to the outer peripheral surface of the first rotatable member is 1.2 times or more than an absolute value of maximum value of magnetic flux density of the fourth magnetic pole in a normal direction with respect to the outer peripheral surface of the first rotatable member.

5. The developing apparatus according to claim 4, wherein
an absolute value of maximum value of magnetic flux density of the third magnetic pole in a normal direction with respect to the outer peripheral surface of the first rotatable member is 1.25 times or more than an absolute value of maximum value of magnetic flux density of the fourth magnetic pole in a normal direction with respect to the outer peripheral surface of the first rotatable member.

6. The developing apparatus according to claim 4, wherein
an absolute value of maximum value of magnetic flux density of the fourth magnetic pole in a normal direction with respect to the outer peripheral surface of the first rotatable member is 40 mT or more.

7. The developing apparatus according to claim 4, wherein
an absolute value of maximum value of magnetic flux density of the third magnetic pole in a normal direction with respect to the outer peripheral surface of the first rotatable member is 94 mT or less.

8. The developing apparatus according to claim 4, wherein
an absolute value of maximum value of magnetic flux density of the first magnetic pole in a normal direction with respect to the outer peripheral surface of the first rotatable member is 150 mT or more.

9. The developing apparatus according to claim 4, wherein
with respect to the rotational direction of the first rotatable member, a point on the outer peripheral surface of the first rotatable member where an absolute value of magnetic flux density of the second magnetic pole in a normal direction with respect to the outer peripheral surface of the first rotatable member is a maximum value is positioned downstream within 40° from a point on the outer peripheral surface of the first rotatable member where an absolute value of magnetic flux density of the first magnetic pole in a normal direction with respect to the outer peripheral surface of the first rotatable member is a maximum value.

10. The developing apparatus according to claim 4, wherein
an absolute value of maximum value of magnetic flux density of the second magnetic pole in a normal direction with respect to the outer peripheral surface of the first rotatable member is 60% or less of an absolute value of maximum value of magnetic flux density of the first magnetic pole in a normal direction with respect to the outer peripheral surface of the first rotatable member.

11. The developing apparatus according to claim 4, wherein
an absolute value of maximum value of magnetic flux density of the third magnetic pole in a normal direction with respect to the outer peripheral surface of the first rotatable member is equal to or less than an absolute value of maximum value of magnetic flux density of the second magnetic pole in a normal direction with respect to the outer peripheral surface of the first rotatable member.

12. The developing apparatus according to claim 1, wherein
in a state where a half-value width of a magnetic flux density of the third magnetic pole in a normal direction with respect to the outer peripheral surface of the first rotatable member where an absolute value of magnetic flux density of the third magnetic pole in a normal direction with respect to the outer peripheral surface of the first rotatable member is half the value of an absolute value of maximum value of magnetic flux density of the third magnetic pole in a normal direction with respect to the outer peripheral surface of the first rotatable member is referred to as BH1, and
in a state where a half-value width of a magnetic flux density of the fourth magnetic pole in a normal direction with respect to the outer peripheral surface of the first rotatable member where an absolute value of magnetic flux density of the fourth magnetic pole in a normal direction with respect to the outer peripheral surface of the first rotatable member is half the value of an absolute value of maximum value of magnetic flux density of the fourth magnetic pole in a normal direction with respect to the outer peripheral surface of the first rotatable member is referred to as BH2,
a difference between BH1 and BH2 is within a range of ±1°, and
an absolute value of maximum value of magnetic flux density of the third magnetic pole in a normal direction with respect to the outer peripheral surface of the first rotatable member is equal to or greater than an absolute value of maximum value of magnetic flux density of the fourth magnetic pole in a normal direction with respect to the outer peripheral surface of the first rotatable member.

13. The developing apparatus according to claim 12, wherein
an absolute value of maximum value of magnetic flux density of the fourth magnetic pole in a normal direction with respect to the outer peripheral surface of the first rotatable member is 40 mT or more.

14. The developing apparatus according to claim 12, wherein
an absolute value of maximum value of magnetic flux density of the third magnetic pole in a normal direction with respect to the outer peripheral surface of the first rotatable member is 94 mT or less.

15. The developing apparatus according to claim 12, wherein
an absolute value of maximum value of magnetic flux density of the first magnetic pole in a normal direction with respect to the outer peripheral surface of the first rotatable member is 150 mT or more.

16. The developing apparatus according to claim 12, wherein
with respect to the rotational direction of the first rotatable member, a point on the outer peripheral surface of the first rotatable member where an absolute value of magnetic flux density of the second magnetic pole in a normal direction with respect to the outer peripheral surface of the first rotatable member is a maximum value is positioned downstream within 40° from a point on the outer peripheral surface of the first rotatable member where an absolute value of magnetic flux density of the first magnetic pole in a normal direction with respect to the outer peripheral surface of the first rotatable member is a maximum value.

17. The developing apparatus according to claim 12, wherein
an absolute value of maximum value of magnetic flux density of the second magnetic pole in a normal direction with respect to the outer peripheral surface of the first rotatable member is 60% or less of an absolute value of maximum value of magnetic flux density of the first magnetic pole in a normal direction with respect to the outer peripheral surface of the first rotatable member.

18. The developing apparatus according to claim 12, wherein
an absolute value of maximum value of magnetic flux density of the third magnetic pole in a normal direction with respect to the outer peripheral surface of the first rotatable member is equal to or less than an absolute value of maximum value of magnetic flux density of the second magnetic pole in a normal direction with respect to the outer peripheral surface of the first rotatable member.

19. A developing apparatus comprising:
a developing container including a first chamber configured to contain a developer including a toner and a carrier, and a second chamber partitioned from the first chamber by a partition wall;
a first rotatable member to which the developer is supplied, the first rotatable member being configured to carry and feed the developer to a developing position where an electrostatic latent image formed on an image bearing member is developed;
a first magnet provided non-rotatably and stationarily inside the first rotatable member, the first magnet having a first magnetic pole provided to face the image bearing member at the developing position, a second magnetic pole provided downstream of the first magnetic pole and adjacent to the first magnetic pole with respect to a rotational direction of the first rotatable member and having a different magnetic polarity as that of the first magnetic pole, a third magnetic pole provided downstream of the second magnetic pole and adjacent to the second magnetic pole, with respect to the rotational direction of the first rotatable member, and having a different magnetic polarity as that of the second magnetic pole, a fourth magnetic pole provided downstream of the third magnetic pole and adjacent to the third magnetic pole, with respect to the rotational direction of the first rotatable member, and having a different magnetic polarity as that of the third magnetic pole, and a fifth magnetic pole provided downstream of the fourth magnetic pole and adjacent to the fourth magnetic pole, with respect to the rotational direction of the first rotatable member, and having a different magnetic polarity as that of the fourth magnetic pole;
a second rotatable member disposed to face the first rotatable member and configured to receive the developer delivered from the first rotatable member by a magnetic field generated by the first magnet, the second rotatable member being configured to carry and feed the developer after developing the electrostatic latent image to collect the developer in the second chamber;
a second magnet provided non-rotatably and stationarily inside the second rotatable member, the second magnet having a sixth magnetic pole having a different magnetic polarity as that of the fifth magnetic pole, wherein the developer after developing the electrostatic latent image is delivered from the first rotatable member to the second rotatable member by a magnetic field generated between the fifth magnetic pole and the sixth magnetic pole; and
a duct portion including a suction port and configured to extend downstream in the rotational direction of the first rotatable member from the suction port, the duct portion including a first duct wall disposed to face the second rotatable member, and a second duct wall disposed to face the first rotatable member, and also disposed to face the first duct wall and configured to form a space between the first duct wall through which air sucked in through the suction port flows, the second duct wall being positioned on an outer side than the first duct wall with respect to a rotation center of the second rotatable member in a radial direction of the second rotatable member,
wherein,
in a state where an edge of the second duct wall on the suction port side, which is an end point on the first rotatable member side, is referred to as a point P,
a point on an outer peripheral surface of the first rotatable member where an absolute value of magnetic flux density of the third magnetic pole in a normal direction with respect to the outer peripheral surface of the first rotatable member is a maximum value is referred to as a point T,
a point on an outer peripheral surface of the first rotatable member where an absolute value of magnetic flux density of the fourth magnetic pole in a normal direction with respect to the outer peripheral surface of the first rotatable member is a maximum value is referred to as a point R, and
a point where a straight line passing the point P and a rotation center O of the first rotatable member intersects the outer peripheral surface of the first rotatable member is referred to as a point Q,
the point Q is positioned downstream of the point T and upstream of the point R with respect to the rotational direction of the first rotatable member, and
wherein
an absolute value of maximum value of magnetic flux density of the third magnetic pole in a normal direction with respect to the outer peripheral surface of the first rotatable member is 1.2 times or more than an absolute value of maximum value of magnetic flux density of the fourth magnetic pole in a normal direction with respect to the outer peripheral surface of the first rotatable member.

20. A developing apparatus comprising:
a developing container including a first chamber configured to contain a developer including a toner and a carrier, and a second chamber partitioned from the first chamber by a partition wall;
a first rotatable member to which the developer is supplied, the first rotatable member being configured to carry and feed the developer to a developing position where an electrostatic latent image formed on an image bearing member is developed;
a first magnet provided non-rotatably and stationarily inside the first rotatable member, the first magnet having a first magnetic pole provided to face the image bearing member at the developing position, a second magnetic pole provided downstream of the first magnetic pole and adjacent to the first magnetic pole, with respect to a rotational direction of the first rotatable member and having a different magnetic polarity as that of the first magnetic pole, a third magnetic pole provided downstream of the second magnetic pole and adjacent to the second magnetic pole, with respect to the rotational direction of the first rotatable member, and having a different magnetic polarity as that of the second magnetic pole, a fourth magnetic pole provided downstream of the third magnetic pole and adjacent to the third magnetic pole, with respect to the rotational direction of the first rotatable member, and having a different magnetic polarity as that of the third magnetic pole, and a fifth magnetic pole provided downstream of the fourth magnetic pole and adjacent to the fourth magnetic pole, with respect to the rotational direction of the first rotatable member, and having a different magnetic polarity as that of the fourth magnetic pole;
a second rotatable member disposed to face the first rotatable member and configured to receive the developer delivered from the first rotatable member by a magnetic field generated by the first magnet, the second rotatable member being configured to carry and feed the developer after developing the electrostatic latent image to collect the developer in the second chamber;
a second magnet provided non-rotatably and stationarily inside the second rotatable member, the second magnet having a sixth magnetic pole having a different magnetic polarity as that of the fifth magnetic pole, wherein the developer after developing the electrostatic latent image is delivered from the first rotatable member to the second rotatable member by a magnetic field generated between the fifth magnetic pole and the sixth magnetic pole; and
a duct portion including a suction port and configured to extend downstream in the rotational direction of the first rotatable member from the suction port, the duct portion including a first duct wall disposed to face the second rotatable member, and a second duct wall disposed to face the first rotatable member, and also disposed to face the first duct wall and configured to form a space between the first duct wall through which air sucked in through the suction port flows, the second duct wall being positioned on an outer side than the first duct wall with respect to a rotation center of the second rotatable member in a radial direction of the second rotatable member,
wherein,
in a state where an edge of the second duct wall on the suction port side, which is an end point on the first rotatable member side, is referred to as a point P,
a point on an outer peripheral surface of the first rotatable member where an absolute value of magnetic flux density of the third magnetic pole in a normal direction with respect to the outer peripheral surface of the first rotatable member is a maximum value is referred to as a point T,
a point on an outer peripheral surface of the first rotatable member where an absolute value of magnetic flux density of the fourth magnetic pole in a normal direction with respect to the outer peripheral surface of the first rotatable member is a maximum value is referred to as a point R, and
a point where a straight line passing the point P and a rotation center O of the first rotatable member intersects the outer peripheral surface of the first rotatable member is referred to as a point Q,
the point Q is positioned downstream of the point T and upstream of the point R with respect to the rotational direction of the first rotatable member, and
wherein
in a state where a half-value width of a magnetic flux density of the third magnetic pole in a normal direction with respect to the outer peripheral surface of the first rotatable member where an absolute value of magnetic flux density of the third magnetic pole in a normal direction with respect to the outer peripheral surface of the first rotatable member is half the value of an absolute value of maximum value of magnetic flux density of the third magnetic pole in a normal direction with respect to the outer peripheral surface of the first rotatable member is referred to as BH1, and
in a state where a half-value width of a magnetic flux density of the fourth magnetic pole in a normal direction with respect to the outer peripheral surface of the first rotatable member where an absolute value of magnetic flux density of the fourth magnetic pole in a normal direction with respect to the outer peripheral surface of the first rotatable member is half the value of an absolute value of maximum value of magnetic flux density of the fourth magnetic pole in a normal direction with respect to the outer peripheral surface of the first rotatable member is referred to as BH2,
a difference between BH1 and BH2 is within a range of ±1°, and
an absolute value of maximum value of magnetic flux density of the third magnetic pole in a normal direction with respect to the outer peripheral surface of the first rotatable member is equal to or greater than an absolute value of maximum value of magnetic flux density of the fourth magnetic pole in a normal direction with respect to the outer peripheral surface of the first rotatable member.
